(19) United States
(12) Patent Application Publication
(10) Pub. No.: US 2024/0334248 A1
(43) Pub. Date: Oct. 3, 2024

(54) METHODS AND SYSTEMS FOR TEMPORARY AND ADAPTIVE LOAD BALANCING FOR INTEGRATED AND WIRELESS ACCESS BACKHAUL

(71) Applicant: Telefonaktiebolaget LM Ericsson (PUBL), Stockholm (SE)

(72) Inventors: Filip BARAC, Huddinge (SE); Jose Luis PRADAS, Stockholm (SE); Ajmal MUHAMMAD, Sollentuna (SE); Ritesh SHREEVASTAV, Upplands Väsby (SE)

(21) Appl. No.: 18/578,594

(22) PCT Filed: Jul. 13, 2022
(86) PCT No.: PCT/EP2022/069688

§ 371 Date: Jan. 11, 2024

Related U.S. Application Data
(60) Provisional application No. 63/221,207, filed on Jul. 13, 2021.

(51) Int. Cl. H04W 28/086; H04W 88/08

(52) U.S. Cl. CPC H04W 28/0862; H04W 88/085

(57) ABSTRACT

A method (700) by a first Centralized Unit, CU1, (20) in an Integrated Access and Backhaul, IAB, network includes transmitting (702) a first message to a second CU, CU2, (30) or receiving a first message from the CU2. The first message includes information indicating that a portion of offloaded traffic is to be returned to the CU1, and the offloaded traffic was previously offloaded from the CU1 to the CU2.

### TECHNICAL FIELD

The present disclosure relates, in general, to wireless communications and, more particularly, systems and methods for temporary and adaptive load balancing for integrated and wireless access backhaul.

### BACKGROUND

3^{rd} Generation Partnership Project (3GPP) has completed the integrated access and wireless access backhaul in New Radio (IAB) Rel-16 and is currently standardizing the IAB Rel-17.

The usage of short range mmWave spectrum in New Radio (NR) creates a need for densified deployment with multi-hop backhauling. However, optical fiber to every base station will be too costly and sometimes not even possible (e.g. historical sites). The main IAB principle is the use of wireless links for the backhaul (instead of fiber) to enable flexible and very dense deployment of cells without the need for densifying the transport network. Use case scenarios for IAB may include coverage extension, deployment of massive number of small cells and fixed wireless access (FWA) (e.g. to residential/office buildings). The larger bandwidth available for NR in mmWave spectrum provides opportunity for self-backhauling, without limiting the spectrum to be used for the access links. On top of that, the inherent multi-beam and Multiple Input Multiple Output (MIMO) support in NR reduce cross-link interference between backhaul and access links allowing higher densification.

During the study item phase of the IAB work, it has been agreed to adopt a solution that leverages the Central Unit (CU)/Distributed Unit (DU) split architecture of NR, where the IAB node will be hosting a DU part that is controlled by a central unit. See, 3GPP TR 38.874. The IAB nodes also have a Mobile Termination (MT) that is used to communicate with parent nodes.

The specifications for IAB strives to reuse existing functions and interfaces defined in NR. In particular, MT, gNodeB-Distributed Unit (gNB-DU), gNodeB-Central Unit (gNB-CU), User Plane Function (UPF), Applications Management Function (AMF), and Session Management Function (SMF) as well as the corresponding interfaces NR Uu (between MT and gNB), F1, NG, X2 and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The MT function has been defined as a component of the IAB node. In the context of this study, MT is referred to as a function residing on an IAB-node that terminates the radio interface layers of the backhaul Uu interface toward the IAB-donor or other IAB-nodes.

FIG. 1 illustrates a high-level architectural view of IAB network. Specifically, FIG. 1 is a reference diagram for IAB in standalone mode, as discussed in 3GPP TR 38.874. The IAB network contains one IAB-donor and multiple IAB-nodes. The IAB-donor is treated as a single logical node that comprises a set of functions such as gNodeB-DU (gNB-DU), gNodeB-CU-Control Plane (gNB-CU-CP), gNodeB-CU-User Plane (gNB-CU-UP), and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

FIG. 2 illustrates the baseline user plane (UP) protocol stacks for IAB in Rel-16, and FIG. 3 illustrates the baseline control plane (CP) protocol stacks for IAB in Rel-16.

As shown above, the chosen protocol stacks reuse the current CU-DU split specification in Rel-15, where the full user plane F1-U (GTP-U/UDP/IP) is terminated at the IAB node (like a normal DU) and the full control plane F1-C (F1-AP/SCTP/IP) is also terminated at the IAB node (like a normal DU). In the above cases, Network Domain Security (NDS) has been employed to protect both UP and CP traffic (IPsec in the case of UP, and Datagram Transport Layer Security (DTLS) in the case of CP). IPsec could also be used for the CP protection instead of DTLS (in this case no DTLS layer would be used).

A new protocol layer called Backhaul Adaptation Protocol (BAP) has been introduced in the IAB nodes and the IAB donor, which is used for routing of packets to the appropriate downstream/upstream node and also mapping the user equipment (UE) bearer data to the proper backhaul Radio Link Control (RLC) channel (and also between ingress and egress backhaul RLC channels in intermediate IAB nodes) to satisfy the end-to-end Quality of Service (QoS) requirements of bearers. Therefore, the BAP layer is in charge of handling the backhaul (BH) RLC channel such as, for example, to map an ingress BH RLC channel from a parent/child IAB node to an egress BH RLC channel in the link towards a child/parent IAB node. In particular, one BH RLC channel may convey end-user traffic for several Data Radio Bearers (DRBs) and for different user equipments (UEs) which could be connected to different IAB nodes in the network.

In 3GPP, two possible configurations of BH RLC channel have been provided. The first configuration includes a 1:1 mapping between BH RLC channel and a specific user's DRB. The second configuration includes a N: 1 bearer mapping where N DRBs possibly associated to different UEs are mapped to 1 BH RLC channel. The first case can be easily handled by the IAB node's scheduler since there is a 1:1 mapping between the QoS requirements of the BH RLC channel and the QoS requirements of the associated DRB. However, this type of 1:1 configuration is not easily scalable in case an IAB node is serving many UEs/DRBs. On the other hand, the N:1 configuration is more flexible/scalable, but ensuring fairness across the various served BH RLC channels might be trickier, because the amount of DRBs/UEs served by a given BH RLC channel might be different from the amount of DRBs/UEs served by another BH RLC channel.

On the IAB-node, the BAP sublayer contains one BAP entity at the MT function and a separate co-located BAP entity at the DU function. On the IAB-donor-DU, the BAP sublayer contains only one BAP entity. Each BAP entity has a transmitting part and a receiving part. The transmitting part of the BAP entity has a corresponding receiving part of a BAP entity at the IAB-node or IAB-donor-DU across the backhaul link.

FIG. 4 illustrates one example of a functional view of the BAP sublayer. The figure is based on the radio interface protocol architecture defined in 3GPP TS 38.300 but this functional view should not restrict implementation. In the example of FIG. 4, the receiving part on the BAP entity delivers BAP Protocol Data Units (PDUs) to the transmitting part on the collocated BAP entity. Alternatively, the receiving part may deliver BAP Service Data Units (SDUs) to the collocated transmitting part. When passing BAP SDUs, the receiving part removes the BAP header, and the transmitting part adds the BAP header with the same BAP routing ID as carried on the BAP PDU header prior to removal. Passing BAP SDUs in this manner is therefore functionally equivalent to passing BAP PDUs, in implementation.

The following services are provided by the BAP sublayer to upper layers:
data transfer;

A BAP sublayer expects the following services from lower layers per RLC entity (for a detailed description sec 3GPP TS 38.322):
acknowledged data transfer service;
unacknowledged data transfer service.

The BAP sublayer supports the following functions:
Data transfer;
Determination of BAP destination and path for packets from upper layers;
Determination of egress BH RLC channels for packets routed to next hop;
Routing of packets to next hop;
Differentiating traffic to be delivered to upper layers from traffic to be delivered to egress link;
Flow control feedback and polling signalling;

Therefore, the BAP layer is fundamental to determine how to route a received packet. For the downstream that implies determining whether the packet has reached its final destination, in which case the packet will be transmitted to UEs that are connected to this IAB node as access node, or to forward it to another IAB node in the right path. In the first case, the BAP layer passes the packet to higher layers in the IAB node which are in charge of mapping the packet to the various QoS flows and hence DRBs which are included in the packet. In the second case instead, the BAP layer determines the proper egress BH RLC channel on the basis of the BAP destination, path IDs and ingress BH RLC channel. Same as the above applies also to the upstream, with the only difference that the final destination is always one specific donor DU/CU. In order to achieve the above tasks, the BAP layer of the IAB node has to be configured with a routing table mapping ingress RLC channels to egress RLC channels which may be different depending on the specific BAP destination and path of the packet. Hence, the BAP destination and path identifier (ID) are included in the header of the BAP packet so that the BAP layer can determine where to forward the packet.

Additionally, the BAP layer has an important role in the hop-by-hop flow control. In particular a child node can inform the parent node about possible congestions experienced locally at the child node, so that the parent node can throttle the traffic towards the child node. The parent node can also use the BAP layer to inform the child a node in case of Radio Link Failure (RLF) issues experienced by the parent, so that the child can possibly reestablish its connection to another parent node.

Topology adaptation in IAB networks may be needed for various reasons, e.g. changes in the radio conditions, changes to the load under the serving CU, radio link failures, etc. The consequence of an IAB topology adaptation could be that an IAB node is migrated (i.e. handed-over) to a new parent (which can be controlled by the same or different CU) or that some traffic currently served by such IAB node is offloaded via a new route (which can be controlled by the same or different CU). If the new parent of the IAB node is under the same CU or a different CU, the migration is intra-donor and inter-donor one, respectively (herein also referred to as the intra-CU and inter-CU migration).

FIG. 5 illustrates an example of some different possible IAB-node migration (i.e. topology adaptation) scenarios for IAB topology adaptation. The scenarios are listed in the order of complexity.

In Intra-CU Case (A), the IAB-node (c) along with it serving UEs is moved to a new parent node (IAB-node (b)) under the same donor-DU (1). The successful intra-donor DU migration requires establishing UE context setup for the IAB-node (e) MT in the DU of the new parent node (IAB-node (b)), updating routing tables of IAB nodes along the path to IAB-node (e) and allocating resources on the new path. The IP address for IAB-node (c) will not change, while the F1-U tunnel/connection between donor-CU (1) and IAB-node (e) DU will be redirected through IAB-node (b).

The procedural requirements/complexity of the Intra-CU Case (B) are the same as that of Case (A). Also, since the new IAB-donor DU (i.e., DU2) is connected to the same L2 network, the IAB-node (e) can use the same IP address under the new donor DU. However, the new donor DU (i.e. DU2) will need to inform the network using IAB-node (e) L2 address in order to get/keep the same IP address for IAB-node (e) by employing some mechanism such as Address Resolution Protocol (ARP).

The Intra-CU Case (C) is more complex than Case (A) as it also needs allocation of new IP address for IAB-node (c). In case, IPsec is used for securing the F1-U tunnel/connection between the Donor-CU (1) and IAB-node (e) DU, then it might be possible to use existing IP address along the path segment between the Donor-CU (1) and Security Gateway (SeGW), and new IP address for the IPsec tunnel between SeGW and IAB-node (c) DU.

Inter-CU Case (D) is the most complicated case in terms of procedural requirements and may needs new specification procedures (such as enhancement of RRC, F1AP, XnAP, Ng signaling) that are beyond the scope of 3GPP Rel-16.

3GPP Rel-16 specifications only consider procedures for intra-CU migration. Inter-CU migration requires new signalling procedures between source and target CU in order to migrate the IAB node contexts and its traffic to the target CU, such that the IAB node operations can continue in the target CU and the QoS is not degraded. Inter-CU migration will be specified in the context of 3GPP Rel17.

During the intra-CU topology adaptation, both the source and the target parent node are served by the same IAB-donor-CU. The target parent node may use a different IAB-donor-DU than the source parent node. The source path may further have common nodes with the target path.

FIG. 6 illustrates an example of the topology adaptation procedure, where the target parent node uses a different IAB-donor-DU than the source parent node. As depicted the IAB Intra-CU topology adaptation procedure includes:
1. The migrating IAB-MT sends a MeasurementReport message to the source parent node IAB-DU. This report is based on a Measurement Configuration the migrating IAB-MT received from the IAB-donor-CU before.
2. The source parent node IAB-DU sends an UL RRC MESSAGE TRANSFER message to the IAB-donor-CU to convey the received MeasurementReport.
3. The IAB-donor-CU sends a UE CONTEXT SETUP REQUEST message to the target parent node IAB-DU to create the UE context for the migrating IAB-MT and set up one or more bearers. These bearers can be used by the migrating IAB-MT for its own signalling, and, optionally, data traffic.
4. The target parent node IAB-DU responds to the IAB-donor-CU with a UE CONTEXT SETUP RESPONSE message.
5. The IAB-donor-CU sends a UE CONTEXT MODIFICATION REQUEST message to the source parent node IAB-DU, which includes a generated RRCReconfiguration message. The RRCReconfiguration message includes a default BH RLC channel and a default BAP Routing ID configuration for UL F1-C/non-F1 traffic mapping on the target path. It may include additional BH RLC channels. This step may also include allocation of TNL address(es) that is (are) routable via the target IAB-donor-DU. The new TNL address(es) may be included in the RRCReconfiguration message as a replacement for the TNL address(es) that is (are) routable via the source IAB-donor-DU. In case IPsec tunnel mode is used to protect the F1 and non-F1 traffic, the allocated TNL address is outer IP address. The TNL address replacement is not necessary if the source and target paths use the same IAB-donor-DU. The Transmission Action Indicator in the UE CONTEXT MODIFICATION REQUEST message indicates to stop the data transmission to the migrating IAB-node.
6. The source parent node IAB-DU forwards the received RRCReconfiguration message to the migrating IAB-MT.
7. The source parent node IAB-DU responds to the IAB-donor-CU with the UE CONTEXT MODIFICATION RESPONSE message.
8. A Random Access procedure is performed at the target parent node IAB-DU.
9. The migrating IAB-MT responds to the target parent node IAB-DU with an RRCReconfigurationComplete message.
10. The target parent node IAB-DU sends an UL RRC MESSAGE TRANSFER message to the IAB-donor-CU to convey the received RRCReconfigurationComplete message. Also, uplink packets can be sent from the migrating IAB-MT, which are forwarded to the IAB-donor-CU through the target parent node IAB-DU. These UL packets belong to the IAB-MT's own signalling and, optionally, data traffic.
11. The IAB-donor-CU configures BH RLC channels and BAP-sublayer routing entries on the target path between the target parent IAB-node and target IAB-donor-DU as well as DL mappings on the target IAB-donor-DU for the migrating IAB-node's target path. These configurations may be performed at an earlier stage, e.g. immediately after step 3. The IAB-donor-CU may establish additional BH RLC channels to the migrating IAB-MT via RRC message.
12. The F1-C connections are switched to use the migrating IAB-node's new TNL address(es), IAB-donor-CU updates the UL BH information associated to each GTP-tunnel to migrating IAB-node. This step may also update UL FTEID and DL FTEID associated to each GTP-tunnel. All F1-U tunnels are switched to use the migrating IAB-node's new TNL address(es). This step may use non-UE associated signaling in E1 and/or F1 interface to provide updated UP configuration for F1-U tunnels of multiple connected UEs or child IAB-MTs. The IAB-donor-CU may also update the UL BH information associated with non-UP traffic. Implementation must ensure the avoidance of potential race conditions, i.e. no conflicting configurations are concurrently performed using UE-associated and non-UE-associated procedures.
13. The IAB-donor-CU sends a UE CONTEXT RELEASE COMMAND message to the source parent node IAB-DU.
14. The source parent node IAB-DU releases the migrating IAB-MT's context and responds to the IAB-donor-CU with a UE CONTEXT RELEASE COMPLETE message.
15. The IAB-donor-CU releases BH RLC channels and BAP-sublayer routing entries on the source path between source parent IAB-node and source IAB-donor-DU.
NOTE: In case that the source path and target path have common nodes, the BH RLC channels and BAP-sublayer routing entries of those nodes may not need to be released in Step 15.
Steps 11, 12 and 15 should also be performed for the migrating IAB-node's descendant nodes, as follows:
   The IAB-donor-CU may allocate new TNL address(es) that is (are) routable via the target IAB-donor-DU to the descendent nodes via RRCReconfiguration message.
   If needed, the IAB-donor-CU may also provide a new default UL mapping which includes a default BH RLC channel and a default BAP Routing ID for UL F1-C/non-F1 traffic on the target path, to the descendant nodes via RRCReconfiguration message.
   If needed, the IAB-donor-CU configures BH RLC channels, BAP-sublayer routing entries on the target path for the descendant nodes and the BH RLC channel mappings on the descendant nodes in the same manner as described for the migrating IAB-node in step 11.
   The descendant nodes switch their F1-C connections and F1-U tunnels to new TNL addresses that are anchored at the new IAB-donor-DU, in the same manner as described for the migrating IAB-node in step 12.
Based on implementation, these steps can be performed after or in parallel with the handover of the migrating IAB-node.
NOTE: In upstream direction, in-flight packets between the source parent node and the IAB-donor-CU can be delivered even after the target path is established.
NOTE: In-flight downlink data in the source path may be discarded, up to implementation via the NR user plane protocol (3GPP TS 38.425).
NOTE: The IAB-donor-CU can determine the unsuccessfully transmitted downlink data over the backhaul link by implementation.

As mentioned above, 3GPP Rel-16 has standardized only intra-CU topology adaptation procedure. Considering that inter-CU migration will be an important feature of IAB Rel-17 Work Item enhancements to existing procedure are required for reducing service interruption (due to IAB-node migration) and signaling load.

Some use cases for inter-donor topology adaptation (aka inter-CU migration) are:
Inter-donor load balancing. One possible scenario is that a link between an IAB node and its parent becomes congested. In this case, the traffic of an entire network branch, below and including the said IAB node (herein referred to as the top-level IAB node) may be redirected to reach the top-level node via another route. If the new route for the offloaded traffic includes traversing the network under another donor before reaching the top-level node, the scenario is an inter-donor routing one. The offloaded traffic may include both the traffic terminated at the top-level IAB node and its served UEs, or the traffic traversing the top-level IAB node, and terminated at its descendant IAB nodes and UEs. In this case, the MT of the top-level IAB node (i.e. top-level IAB-MT) may establish an RRC connection to another donor (thus releasing its RRC connection to the old donor), and the traffic towards this node and its descendant devices is now sent via the new donor.
Inter-donor RLF recovery. An IAB node experiencing an RLF on its parent link attempts RRC reestablishment towards a new parent under another donor (this node can also be referred to as the top-level IAB node). According to 3GPP agreements, if the descendant IAB nodes and UEs of the top-level node “follow” to the new donor, the parent-child relations are retained after the top-level node connects to another donor.

The above cases assume that the top-level node's IAB-MT can connect to only one donor at a time. However, Rel-17 work will also consider the case where the top-level IAB-MT can simultaneously connect to two donors, in which case:
For load balancing, the traffic reaching the top-level IAB node via one leg may be offloaded to reach the top-level IAB node (and, potentially, its descendant nodes) via the other leg that the node established to another donor.
For RLF recovery, the traffic reaching the top-level IAB node via the broken leg can be redirected to reach the node via the “good” leg, towards the other donor.

With respect to inter-donor topology adaptation, the 3GPP Rel-17 specifications will allow two alternatives:
Proxy-based solution: Assuming that top-level IAB-MT is capable of connecting to only one donor at a time, the top-level IAB-MT migrates to a new donor, while the F1 and RRC connections of its collocated IAB-DU and all the descendant IAB-MTs, IAB-DUs and UEs remain anchored at the old donor, even after inter-donor topology adaptation.
   Proxy-based solution is also applicable in case when top-level IAB-MT is simultaneously connected to two donors. In this case, some or all of the traffic traversing/terminating at the top-level node is offloaded via the leg towards the ‘other’ donor.
Full migration-based solution: All the F1 and RRC connections of the top-level node and all its descendant devices and UEs are migrated to the new donor.

The details of both solutions are currently under discussion in 3GPP.

One drawback of the full migration-based solution for inter-CU migration is that a new F1 connection is set up from IAB-node E to the new CU (i.e. CU (2)) and the old F1 connection to the old CU (i.e. CU (1)) is released.

Releasing and relocating the F1 connection will impact all UEs (i.e., UE_{c}, UE_{d}, and UEₑ) and any descendant IAB nodes (and their served UEs) by causing:
1. Service interruption for the UEs and IAB nodes served by the top-level IAB node (i.e., IAB-node E) since these UEs may need to re-establish their connection or to perform handover operation (even if they remain under the same IAB node, as 3GPP security principles mandate to perform key refresh whenever the serving CU/gNB is changed (e.g., at handover or reestablishment), i.e., RRC reconfiguration with reconfigurationWithSync has to be sent to each UE).

2. A signaling storm, since a large number of UEs, IAB-MTs and IAB-DUs have to perform re-establishment or handover at the same time.

In addition, according to certain embodiments, it may be preferred that any reconfiguration of the descendant nodes of the top-level node is avoided. This means that the descendant nodes should preferably be unaware of the fact that the traffic is proxied via CU2.

To address the above problems, a proxy-based mechanism has been proposed where the inter-CU migration is done without handing over the UEs or IAB nodes directly or indirectly being served by the top-level IAB node, thereby making the handover of the directly and indirectly served UEs transparent to the target CU. In particular, only the Radio Resource Control (RRC) connection of the top-level IAB node is migrated to the target CU, while the CU-side termination of its F1 connection as well as the CU-side terminations of the F1 and RRC connections of its directly and indirectly served IAB nodes and UEs are kept at the source CU—in this case, the target CU serves as the proxy for these F1 and RRC connections that are kept at the source CU. Hence in this case, the target CU just needs to ensure that the ancestor node of the top-level IAB node are properly configured to handle the traffic from the top-level node to the target donor, and from the target donor to the top-level node. Meanwhile, the configuration of the descendant IAB node of the said top-level node are still under the control of the source donor. Hence, in this case the target donor does not need to know the network topology and the QoS requirements or the configuration of the descendant IAB nodes and UEs.

FIG. 7 illustrates an example of signal flow before IAB-node 3 migration. FIG. 8 illustrates an example of signal flow after IAB-node 3 migration. Specifically, FIG. 7 illustrates the signalling connections when the F1 connections are maintained in the CU-1, while FIG. 8 highlights how the F1-U is tunnelled over the Xn and then transparently forwarded to the IAB donor-DU-2 after the IAB node is migrated to the target donor CU (i.e. CU2).

FIG. 9 illustrates an example of proxy-based solution for inter-donor load balancing. Specifically, the solution involves IAB3 and its descendant node IAB4 and the UEs that these two IAB nodes are serving.

Applied to the scenario from FIG. 9, the proxy-based solution works as follows:
IAB3-MT changes its RRC connection (i.e., association) from CU1 to CU2.
Meanwhile, the RRC connections of IAB4-MT and all the UEs served by IAB3 and IAB4, as well as the F1 connections of IAB3-DU and IAB4-DU would remain anchored at CU1 (i.e. they are not moved to CU2), whereas the corresponding traffic of these connections is sent to and from the IAB3/IAB4 and their served UEs by using a path via CU2.

So, the traffic previously sent from the source donor (i.e., CU1 in FIG. 2-9) to the top-level IAB node (IAB3) and its descendants (e.g. IAB4) is offloaded (i.e. proxied) via CU2. In particular:
The old traffic path from CU1 to IAB4, i.e. CU1-Donor DU1-IAB2-IAB3-IAB4 is, for load balancing purposes, changed to CU1-Donor DU_2-IAB5-IAB3-IAB4.

Herein, the assumption is that direct routing between CU1 and Donor DU_2 is applied (i.e. CU1-Donor DU1—and so on . . . ), rather than the indirect routing case CU1-CU2-Donor DU1—and so on . . . ). The direct routing can e.g. be supported via IP routing between (source donor) CU1 and donor DU2 (target donor DU) or via an Xn connection between the two. In indirect routing, data can be sent between CU1 and CU2 via Xn interface, and between CU2 and Donor DU_2 via F1 or via IP routing. Both direct and indirect routing are applicable to the embodiments described herein. The advantage of direct routing is that the latency is likely smaller.

3GPP has defined the Dual Active Protocol Stack (DAPS) Handover procedure that maintains the source gNB connection after reception of RRC message (HO Command) for handover and until releasing the source cell after successful random access to the target gNB.

A DAPS handover may be used for an RLC-AM or RLC-UM bearer. For a DRB configured with DAPS, the following principles are additionally applied.

With regard to the Downlink:
During HO preparation, a forwarding tunnel is always established.
The source gNB is responsible for allocating downlink Packet Data Convergence Protocol (PDCP) Sequence Numbers (SNs) until the SN assignment is handed over to the target gNB and data forwarding takes place. That is, the source gNB does not stop assigning PDCP SNs to downlink packets until it receives the HANDOVER SUCCESS message and sends the SN STATUS TRANSFER message to the target gNB.
Upon allocation of downlink PDCP SNs by the source gNB, it starts scheduling downlink data on the source radio link and also starts forwarding downlink PDCP SDUs along with assigned PDCP SNs to the target gNB.
For security synchronisation, Hyper Frame Number (HFN) is maintained for the forwarded downlink SDUs with PDCP SNs assigned by the source gNB. The source gNB sends the EARLY STATUS TRANSFER message to convey the DL COUNT value, indicating PDCP SN and HFN of the first PDCP SDU that the source gNB forwards to the target gNB.
HFN and PDCP SN are maintained after the SN assignment is handed over to the target gNB. The SN STATUS TRANSFER message indicates the next DL PDCP SN to allocate to a packet which does not have a PDCP sequence number yet, even for Radio Link Control-Unacknowledge Mode (RLC-UM).
During handover execution period, the source and target gNBs separately perform Robust Header Compression (ROHC), ciphering, and adding PDCP header.
During handover execution period, the UE continues to receive downlink data from both source and target gNBs until the source gNB connection is released by an explicit release command from the target gNB.
During handover execution period, the UE PDCP entity configured with DAPS maintains separate security and ROHC header decompression functions associated with each gNB, while maintaining common functions for reordering, duplicate detection and discard, and PDCP SDUs in-sequence delivery to upper layers. PDCP SN continuity is supported for both RLC AM and UM DRBs configured with DAPS.

With regard to the Uplink:
The UE transmits UL data to the source gNB until the random access procedure toward the target gNB has been successfully completed. Afterwards the UE switches its UL data transmission to the target gNB.
Even after switching its UL data transmissions towards the target gNB, the UE continues to send UL layer 1 Channel State Information (CSI) feedback, Hybrid Automatic Repeat Request (HARQ) feedback, layer 2 Radio Link Control (RLC) feedback, ROHC feedback, HARQ data re-transmissions, and RLC data re-transmission to the source gNB.
During handover execution period, the UE maintains separate security context and ROHC header compressor context for uplink transmissions towards the source and target gNBs. The UE maintains common UL PDCP SN allocation. PDCP SN continuity is supported for both Radio Link Control-Acknowledge Mode (RLC AM) and RLC-UM DRBs configured with Dual Active Protocol Stack (DAPS).
During handover execution period, the source and target gNBs maintain their own security and ROHC header decompressor contexts to process UL data received from the UE.
The establishment of a forwarding tunnel is optional.
HFN and PDCP SN are maintained in the target gNB. The SN STATUS TRANSFER message indicates the COUNT of the first missing PDCP SDU that the target should start delivering to the 5GC, even for RLC-UM.

At the RAN3#110-e meeting, RAN3 agreed that potential solutions for simultaneous connectivity to two donors may include a “DAPS-like” solution. In that respect, a solution herein referred to as the Dual IAB Protocol Stack (DIPS), has been proposed in 3GPP. FIG. 10 illustrates one example of the DIPS solution.

DIPS is based on:
Two independent protocol stacks, which may include Radio Link Control (RLC)/Medium Access Control (MAC)/Physical Layer (PHY), each connecting to a different CU.
One or two independent BAP entities with some common and some independent functionalities.
Each CU allocates its own resources (e.g., addresses, BH RLC channels, etc.) without the need for coordination, and configures each protocol stack.

In essence, the solution comprises two protocol stacks as in DAPS, with the difference being the BAP entity (-ies) instead of a PDCP layer. A set of BAP functions could be common, and another set of functions could be independent for each parent node.

This type of solution reduces the complexity to the minimum and achieves all the goals of the Work Item, since:
Each protocol stack can be configured independently using current signalling and procedures increasing robustness. Minimal signalling updates might be needed.
Only the top-level IAB node is reconfigured. Everything is transparent for other nodes and UEs which do not require any reconfiguration, resulting in decreasing signalling load and increasing robustness.
It eliminates service interruption, as data can continue flowing over the initial link until the second is set-up.
It avoids the need of IP/BAP addresses and route IDs coordination between CUs, which reduces significantly the complexity and the network signalling.

When the CU determines that load balancing is needed, the CU starts the procedure requesting to a second CU resources to offload part of the traffic of a certain (i.e. top-level) IAB node. The CUs will negotiate the configuration and the second CU will prepare the configuration to apply in the second protocol stack of the IAB-MT, the RLC backhaul channel(s), BAP address(es), etc.

The top-level IAB-MT will use routing rules provided by the CU to route certain traffic to the first or the second CU. In the DL, the IAB-MT will translate the BAP addresses from the second CU to the BAP addresses from the first CU to reach the nodes under the control of the first CU.

All this means that only the top-level IAB node (i.e. the IAB node from which traffic is offloaded) is affected and no other node or UE is aware of this situation. All this procedure can be performed with current signalling, with some minor changes.

FIG. 11 illustrates two scenarios for inter-donor topology redundance as agreed by RAN3. Specifically, the two scenarios for the inter-donor topology redundancy include:
Scenario 1: the IAB is multi-connected with 2 Donors.
Scenario 2: the IAB's parent/ancestor node is multi-connected with 2 Donors. In these two scenarios, RAN3 uses the following terminologies:
Boundary IAB node: the node accesses two different parent nodes connected to two different donor CUs, respectively, e.g., IAB 3 in above figures;
Descendant IAB node: the node(s) accessing to network via boundary IAB node, and each node is single-connected to its parent node, e.g., IAB4 in scenario 2
F1-termination node: the donor CU terminating F1 interface of the boundary IAB node and descendant node(s)
Non-F1-termination node: the CU with donor functionalities, which does not terminate F1 interface of the boundary IAB node and descendant node(s)

There currently exist certain challenge(s), however. For example, as explained above, topology adaptation can be accomplished by using the proxy-based solution (currently referred to as partial inter-donor migration in 3GPP), where, with respect to the scenario shown in FIG. 9, the top-level IAB3-MT changes its RRC connection (i.e., association) from CU1 to CU2. Meanwhile, the RRC connections of IAB4-MT and all the UEs served by IAB3 and IAB4, as well as the F1 connections of IAB3-DU and IAB4-DU remain anchored at CU1, whereas the corresponding traffic of these connections would be sent to and from the IAB3/IAB4 and their served UEs by using the new path (as described above).

Nevertheless, the following should be considered:
It is expected that the need for offloading traffic to another donor would be only temporary (e.g. during peak hours of the day), and that, after a while, the traffic can be returned to the network under the first donor.
It is also expected that millimeter wave links will generally be quite stable, with rare and short interruptions. In that sense, in case topology adaptation was caused by inter-donor RLF recovery, it is expected that it will be possible to establish (again) a stable link towards the (old) parent under the old donor.

Previous methods have included revoking the proxy-based load balancing to another CU. The following scenarios have been addressed:
For a top-level node connected to one donor, revoking of traffic i.e. de-configuring the traffic offloading to another donor (e.g. by means of proxy-based approach, for both load balancing and inter-donor RLF recovery), i.e. moving the traffic back from the proxied path(s) under another donor (e.g., a second CU (CU2)) to its original path(s) under the first donor (e.g., a first CU (CU1)).
For a top-level node simultaneously connected to two donors, revoking of traffic offloading to another CU, where the offloaded traffic is moved from top-level node's leg towards the second donor (e.g. CU2), back to its original leg towards the first donor (e.g. CU1).

Nevertheless, it is still unclear how to, after offloading is set up and becomes functional, to enable:
The CU1 to offload additional traffic to CU2;
The CU1 to revoke the offloading of some of the traffic previously offloaded to CU2, instead of addressing the total revocation of offloading.
The CU2 to request CU1 to revoke offloading some of CU1's traffic that cannot be handle by CU2 due to any reason, such as network under CU2 domain becomes congested, etc.

### SUMMARY

Certain aspects of the disclosure and their embodiments may provide solutions to these or other challenges. For example, certain embodiments disclosed herein relate to methods and systems for the CU1 to request to the CU2 that one or more parameters of the configuration of a previously executed migration (full migration or proxy-based migration) needs to be updated. As another example, certain embodiments relate to methods and systems for the CU2 to request to the CU1 that one or more parameters of the configuration of a previously executed migration (full migration or proxy-based migration) needs to be updated.

According to certain embodiments, a method by a CU1 in an IAB network includes transmitting a first message to a CU2 or receiving a first message from the CU2. The first message includes information indicating that a portion of offloaded traffic is to be returned to the CU1. The offloaded traffic was previously offloaded from the CU1 to the CU2.

According to certain embodiments, a CU1 in an IAB network is adapted to transmit a first message to a CU2 or receiving a first message from the CU2. The first message includes information indicating that a portion of offloaded traffic is to be returned to the CU1. The offloaded traffic was previously offloaded from the CU1 to the CU2.

According to certain embodiments, a method by a CU2 in an IAB network includes transmitting a first message to a CU1 or receiving a first message from the CU1, The first message comprises information indicating that a portion of offloaded traffic is to be returned to the CU1. The offloaded traffic was previously offloaded from the CU1 to the CU2.

According to certain embodiments, a CU2 in an IAB network is adapted to transmit a first message to a CU1 or receiving a first message from the CU1, The first message comprises information indicating that a portion of offloaded traffic is to be returned to the CU1. The offloaded traffic was previously offloaded from the CU1 to the CU2.

Certain embodiments may provide one or more of the following technical advantage(s). For example, certain embodiments may provide a technical advantage of allowing for dynamic control of the network resources for traffic load balancing when two CUs are involved in the procedure.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a high-level architectural view of IAB network;

FIG. 2 illustrates the baseline user plane (UP) protocol stacks for IAB in Rel-16;

FIG. 3 illustrates the baseline control plane (CP) protocol stacks for IAB in Rel-16;

FIG. 4 illustrates one example of a functional view of the BAP sublayer;

FIG. 5 illustrates an example of some different possible IAB-node migration (scenarios for IAB topology adaptation;

FIG. 6 illustrates an example of the topology adaptation procedure, where the target parent node uses a different IAB-donor-DU than the source parent node;

FIG. 7 illustrates an example of signal flow before IAB-node 3 migration;

FIG. 8 illustrates an example of signal flow after IAB-node 3 migration;

FIG. 9 illustrates an example of proxy-based solution for inter-donor load balancing;

FIG. 10 illustrates one example of the DIPS solution;

FIG. 11 illustrates two scenarios for inter-donor topology redundance as agreed by RAN3;

FIG. 12 illustrates an example signaling chart illustrating the exchange of messages between a CU1 and CU2, according to certain embodiments;

FIG. 13 illustrates an example communication system, according to certain embodiments;

FIG. 14 illustrates an example UE, according to certain embodiments;

FIG. 15 illustrates an example network node, according to certain embodiments;

FIG. 16 illustrates a block diagram of a host, according to certain embodiments;

FIG. 17 illustrates a virtualization environment in which functions implemented by some embodiments may be virtualized, according to certain embodiments;

FIG. 18 illustrates a host communicating via a network node with a UE over a partially wireless connection, according to certain embodiments;

FIG. 19 illustrates a method by a CU1 in an IAB network, according to certain embodiments; and

FIG. 20 illustrates a method by a CU2 in an IAB network, according to certain embodiments.

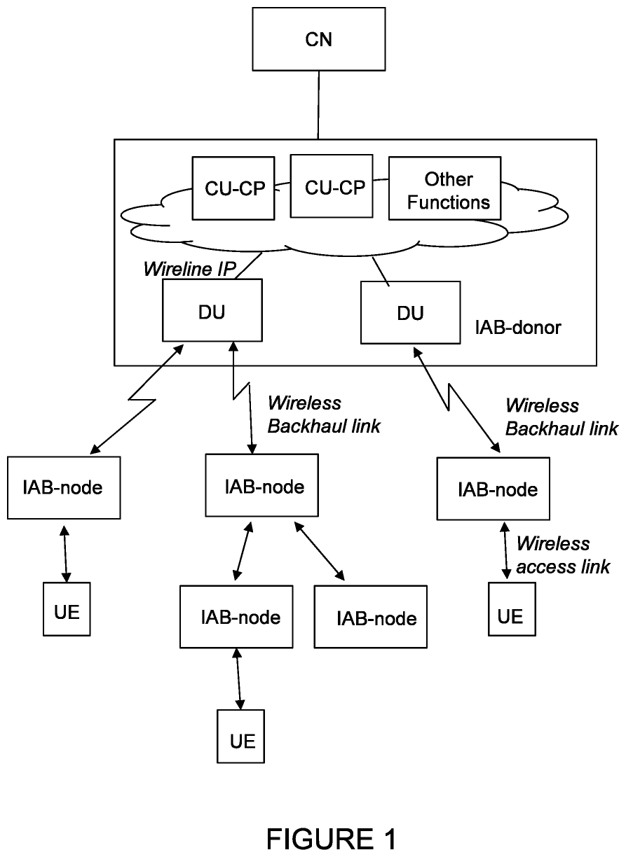

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

Although certain embodiments are described as being exemplified on the case of proxy-based inter-donor migration, the methods and techniques described herein are equally applicable to the full migration based solution in case the network decides or realizes that it may need to fully migrate back from CU2 to CU1 the devices previously fully migrated from CU1 to CU2.

The terms “inter-donor traffic offloading” and “inter-donor migration” and “inter-donor topology adaptation” are used interchangeably.

The term “single-connected top-level node” refers to the top-level IAB-MT that connects to only one donor at a time.

The term “dual-connected top-level node” refers to the top-level IAB-MT that simultaneously connects to two donors, or a IAB with two MTs each of the MTs connected to one donor.

The term “descendant node” may refer to both the child node and the child of the child and so on.

The terms “CU1”, “source donor” and “old donor” are used interchangeably.

The terms “CU_2”, “target donor” and “new donor” are used interchangeably.

The terms “Donor DU1”, “source donor DU” and “old donor DU” are used interchangeably.

The terms “Donor DU2”, “target donor DU” and “new donor DU” are used interchangeably.

The term “parent” may refer to an IAB node or an IAB-donor DU.

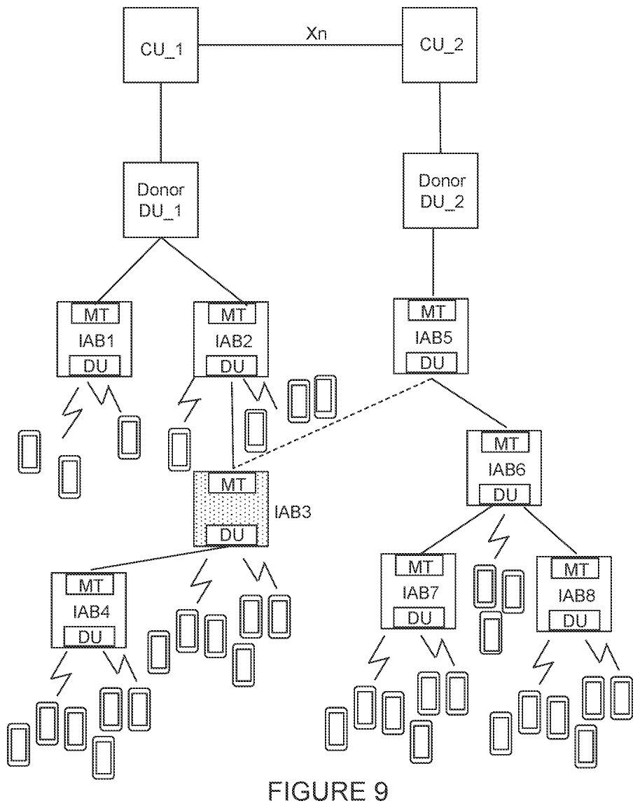

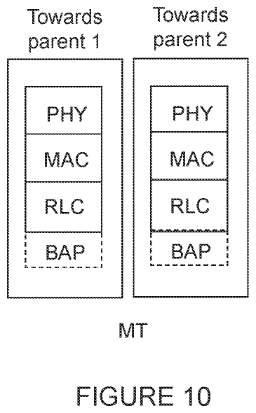

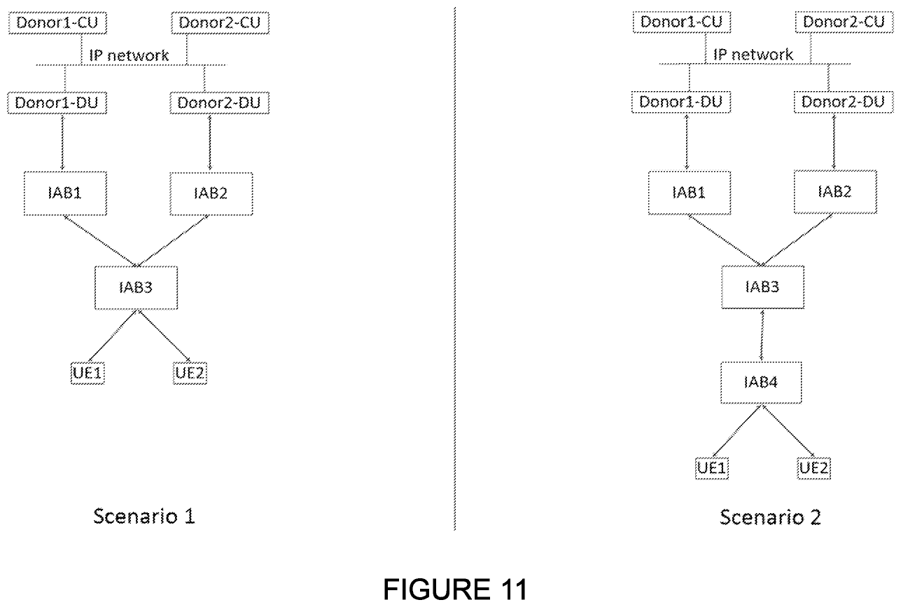

The terms “migrating IAB node” and “top-level IAB node” are used interchangeably:
In the proxy-based solution for inter-donor topology adaptation, they refer to the IAB-MT of this node (e.g. IAB3-MT in FIG. 9), because, in the collocated IAB-DU of the top-level node does not migrate (it maintains the F1 connection to the source donor).
In full migration-based solution, the entire node and its descendants migrate to another donor.

Some non-limiting examples of scenarios that certain embodiments are based on are given below:
Inter-donor load balancing for a dual-connected top-level node (e.g. IAB3-MT for FIG. 9) by using the proxy based solution: Here, the traffic carried to/from/via top-level IAB node is taken over by (i.e. proxied) a target donor (load balancing), i.e. the source donor offloads the traffic pertaining to the ingress/egress BH RLC channels between the said IAB node and its parent node to the top-level node's leg towards the target donor.
Inter-donor RLF recovery of a dual-connected top-level node, caused by RLF on a link to the said IAB node's parent, or on a link between the said IAB node's parent and parent's parent, where the traffic of the said node (i.e. top-level node) is completely moved to the leg of the said node towards the target donor.
IAB node handover to another donor.
Local inter-donor rerouting (UL and/or DL), where the newly selected path towards the donor or the destination IAB node leads via another donor.
Any of the example scenarios above, where full migration-based solution (as described above) is applied (instead of the proxy-based solution).

According to certain embodiments, top-level IAB node consists of top-level IAB-MT and its collocated IAB-DU (sometimes referred to as the “collocated DU” or the “top-level DU”). In certain scenarios, it may also consist of top-level IAB with two MTs and one collocated IAB-DU. Certain aspects of the embodiments described herein refer to the proxy-based solution for inter-donor topology adaptation, and certain refer to the full migration-based solution, described above.

According to certain embodiments, the terms “RRC/F1 connections of descendant devices” refers to the RRC connections of descendant IAB-MTs and UEs with the donor (source donor in this case), and the F1 connections of the top-level IAB-DU and IAB-DUs of descendant IAB nodes of the top-level IAB node with the donor (source donor).

According to certain embodiments, traffic between the CU1 and the top-level IAB node and/or its descendant nodes (also referred to as the proxied traffic) refers to the traffic between the CU1 and:
1. the collocated IAB-DU part of the top-level IAB node (since the IAB-MT part of the top-level IAB node has migrated its RRC connection to the new donor),
2. the descendant IAB nodes of the top-level IAB node, and
3. the UEs served by the top-level node and its descendant nodes.

According to certain embodiments, the assumption is that, for traffic offloading, direct routing between CU1 and Donor DU2 is applied (i.e. CU1-Donor DU2—and so on . . . ), rather than the indirect routing case, where the traffic goes first to CU2, i.e. CU1-CU2-Donor DU2—and so on. . . . The direct routing may, for example, be supported via IP routing between (source donor) CU1 and donor DU2 (target donor DU) or via an Xn connection between the two. In indirect routing, data is sent between CU1 and CU2 via Xn interface, and between CU2 and Donor DU2 via F1 or via IP routing. Both direct and indirect routing are applicable in to the embodiments described herein. The advantage of direct routing is that the latency is likely smaller.

According to certain embodiments, it is assumed that, both user plane and control plane traffic are sent from/to the source donor via target donor to/from the top-level node and its descendants by means of direct and indirect routing.

The term “destination is IAB-DU”, comprises both the traffic whose final destination is either the said IAB-DU or a UE or IAB-MT served by the said IAB-DU, and that includes top-level IAB-DU as well.

The term “data” refers to both user plane, control plane traffic and non-F1 traffic.

The considerations described herein are equally applicable for both static and mobile IAB nodes.

Herein, the terms “old donor” and “CU1” refer to the donor that has previously offloaded traffic to the “new donor”/“CU2”. The starting point is that the connection from CU1 and CU2 towards the migrating IAB node is already established.

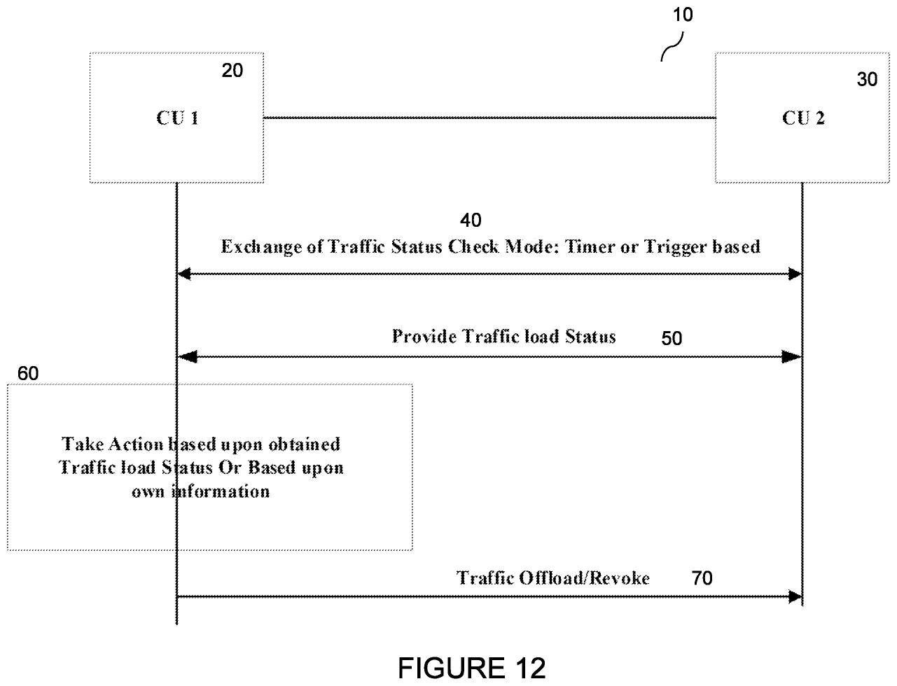

FIG. 12 illustrates an example signaling chart 10 illustrating the exchange of messages between a CU1 20 (e.g., source donor node) and CU2 30 (e.g., target donor node), according to certain embodiments.

As depicted in FIG. 12, either or both of the CU1 20 and the CU2 30 may request traffic status information at 40. In particular embodiments, the request(s) may be timer or trigger based. In response to the requests for traffic status information (or alternatively preemptively and/or without receiving a request), the CU1 20 and/or the CU2 30 may provide the traffic load status, at 50. Thereafter, at 60, the CU1 20 may take action based upon the obtained traffic load status from the CU2 30 or based on information obtained directly by the CU1 20. at 70, the CU1 20 may then offload traffic to the CU230 or revoke traffic that was previously offloaded to the CU2 30. In the latter case, the CU1 20 resumes handling of traffic that was previously offloaded to the CU2 30.

### Dynamic Offloading Request by CU1

According to certain embodiments, a method including a dynamic offloading request by CU1 includes:
Step 1: CU1 determines the need to 1) offload additional traffic load to CU2, or 2) retrieve some of the traffic previously offloaded to CU2 back to CU1. The reference to some of the traffic previously offloaded may refer to only some of the traffic previously offloaded.
Step 2: If CU1 determined to offload additional traffic to CU2:
   Step 2.1: CU1 requests from CU2 additional resources. These resources could be downlink, uplink, or both.
   Step 2.2: CU2 responds to CU1 either negatively, i.e. no additional resources granted, or positively, with additional resources granted. These additional resources may be different from the resources initially requested in step 2.1.
   Step 2.3: Based on the response from CU2, CU1 may update the IAB nodes routing tables for the affected routes and UEs/nodes. The resulting outcome is that additional CU1 traffic is offloaded via CU2.
Step 3: If CU1 determined to retrieve back some of the previously offloaded traffic to CU2:
   Step 3.1: CU1 may inform CU2 that it can reduce the resource allocation for offloading, i.e. that some of the previously offloaded traffic can be returned to CU1. These resources (allocated for CU1 offloaded traffic) could be downlink, uplink, or both.
   Step 3.2: CU2 may respond to CU1 with an acknowledgment. CU2 may release the corresponding resources associated with the offloaded traffic that is transferred back to CU1.
   Step 3.3: CU1 updates the IAB nodes routing tables for the affected routes and UEs/nodes. The resulting outcome would be that more traffic is routed via CU1 and less over CU2 (because some of the previously offloaded traffic is returned to CU1).

### Dynamic Offloading Request by CU2

According to certain embodiments, a method including a dynamic offloading request by CU2 includes:
Step 1: CU2 determines 1) it can take additional traffic from CU1 (if previously CU2 could not fully provided the resources requested by CU1, or 2) it needs to reduce the allocated resources to the migrating IAB node due to any reason, such as surge in traffic demand from its own (i.e., under CU2 domain) IAB nodes, etc. Analogously to the offloading request from CU1, the reducing of the allocated resources may refer to only some of the offloaded traffic.
Step 2: If CU2 determined it can provide additional resources to offload traffic from CU1:
   Step 2.1: CU2 informs to CU1 that it can take additional traffic from CU1. These resources could be downlink, uplink, or both. CU2 can also inform the amount of additional resources that it can offer to CU1.
   Step 2.2: CU1 responds to CU2 either negatively, i.e., if no additional resources are needed any longer, or it can respond positively, i.e., accepting the offered resources.
   Step 2.2′: CU2 may send to CU1 with an acknowledgement to handshake the procedure.

Step 2.3: Based on the response from CU1 in step 2.2. or 2.2′, CU1 may update the IAB nodes routing tables for the affected IAB nodes and UEs. The resulting outcome is that additional traffic is now offloaded via CU2.
Step 3: If CU2 determined that it needs to reduce the allocated resources:
   Step 3.1: CU2 informs CU1 that it needs to reduce the resource allocation. These resources could be downlink, uplink, or both. It also indicates which resources (i.e., BH RLC channels) will be reduced/terminated.
   Step 3.2: CU1 may respond to CU2 with:
      Step 3.2.1: an acknowledgment indicating the acceptance of CU2 request, or
      Step 3.2.2: alternatively, a second request for resource allocation which may include different configurations than previously configured. This could be done to adapt/tailored the traffic and corresponding QoS requirements in accordance to the request from CU2.
         Optionally, Step 3.2.2.1: CU2 may respond to the request from CU1 by accepting the new request, rejecting it, or providing a different resource allocation. This may loop returns to Step 2.2.
   Step 3.3: CU1 updates the IAB nodes routing tables for the affected UEs and IAB nodes. The resulting outcome would be that more traffic is routed via CU1 and less over CU2.

References to a portion of offloaded traffic returned to the originating CU (e.g. CU1) or retrieving some of the traffic previously offloaded may be considered as referring to only a portion of the offloaded traffic, or retrieving only a portion of the offloaded traffic. As such, the “portion” or “some” of the traffic refers to less than the full amount of the traffic previously offloaded, i.e. only a part of the traffic previously offloaded.

### Timer Based Poling or On-Demand Status Check for Adaptive/Dynamic Traffic Sharing

According to certain embodiments, when multiple CUs are involved for load sharing (traffic offloading) (e.g. CU1 and CU2 as provided in examples in above sections), the CU which has the F1 connection (CU1) may configure a timer towards the CU2 and/or top-level IAB node. Upon expiry of such timer, the polled network entity would provide the traffic congestion status. This status may be indicated by a simple flag (loaded/unloaded i.e. do not have capacity, has capacity). Alternatively, this can be indicated by providing bit rate; how much traffic the new CU (e.g. CU2) can handle from the CU which needs to offload the traffic (CU1).

Based upon such feedback on a pre-configured time-based poling, CU1 determines whether it can offload additional traffic or if it needs to revoke some of the traffic from CU2, according to certain embodiments. The timer may be explicitly signaled or may be an implicit default value when multiple CUs are involved for load sharing.

According to certain embodiments, the polling may also be independent of a timer whereby CU1 or CU2 performs the status check on-demand. However, the trigger or event of such status check may be pre-configured, in certain embodiments, in order to avoid too much signaling that may occur between multiple CUs if the trigger conditions are not well defined.

According to particular embodiments, example of such triggers may be:
Top-level IAB node has either spike gradual increase of traffic (load increase by certain threshold for certain pre-configured duration; the traffic load threshold may be configured in terms of bit rates (for example)), in a particular embodiment. In this case, the additional traffic then further needs to be offloaded to CU2
Top-level IAB node has decline of traffic load (by certain configured threshold). This may give opportunity for CU1 to revoke some of the traffic from CU2.
Any of the parent nodes from CU2 handling traffic to/from top-level node becomes congested (by certain margin for certain duration) or if there is decline in traffic load (by certain margin for certain duration).

According to certain embodiments, the initiation of such polling information can be indicated by using a new light weight Xn signaling message or appending it to existing signaling such as part of handover preparation procedure or Secondary Node setup procedure (Master-Node, Secondary Node Dual connectivity procedure).

According to certain embodiments, the response of such poll (e.g. traffic load status response flag) is a new light weight signaling message.

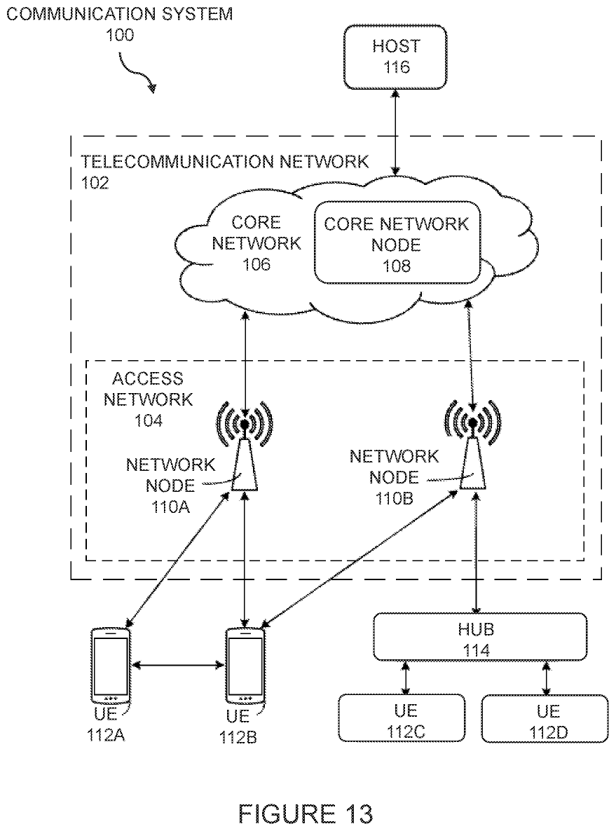

FIG. 13 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

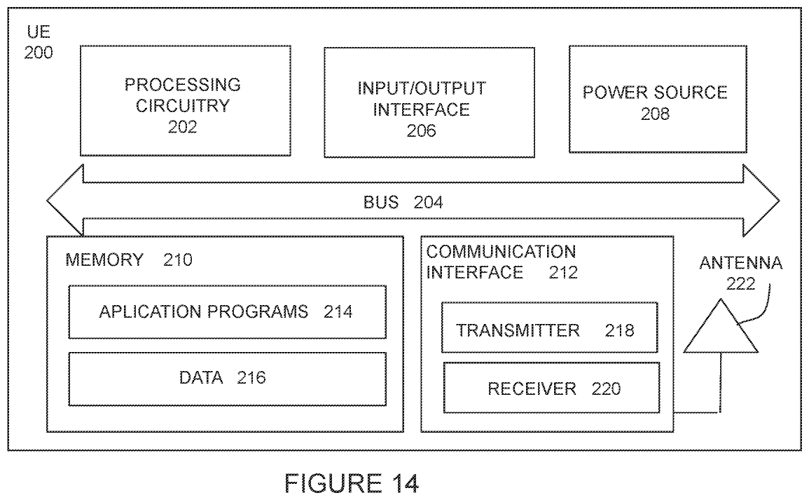

FIG. 14 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 14. As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

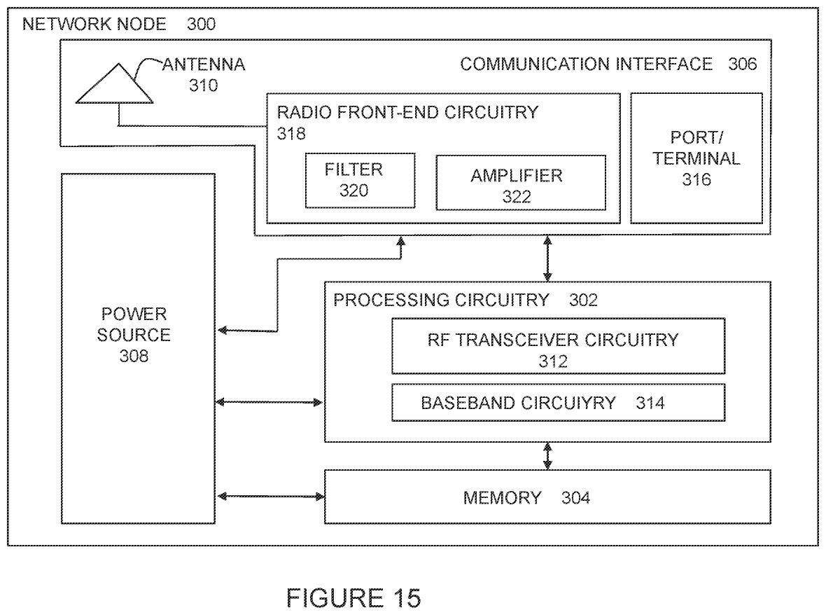

FIG. 15 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, cither alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 15 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

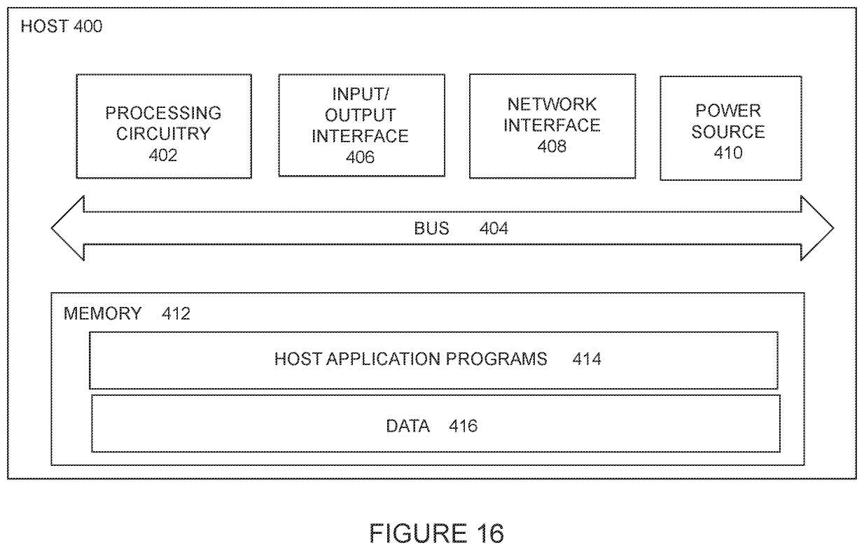

FIG. 16 is a block diagram of a host 400, which may be an embodiment of the host 116 of FIG. 13, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

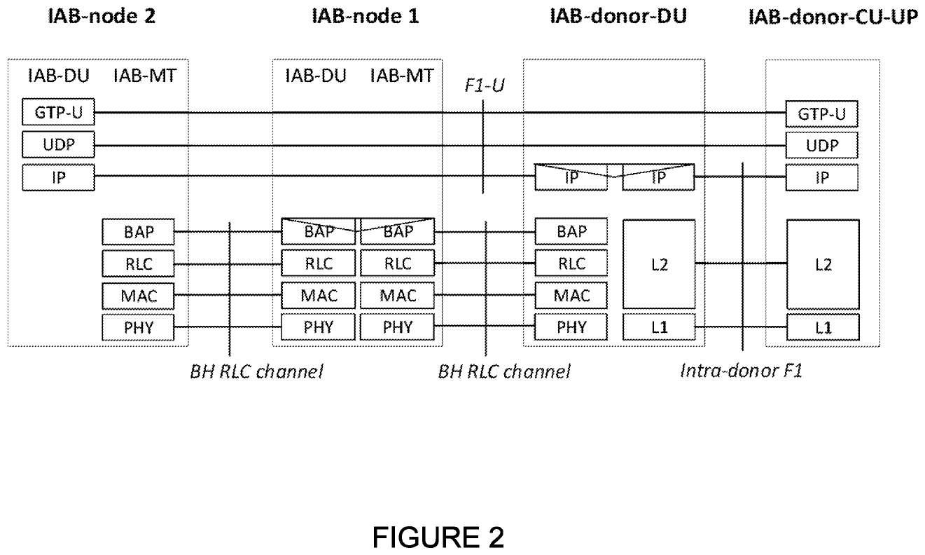

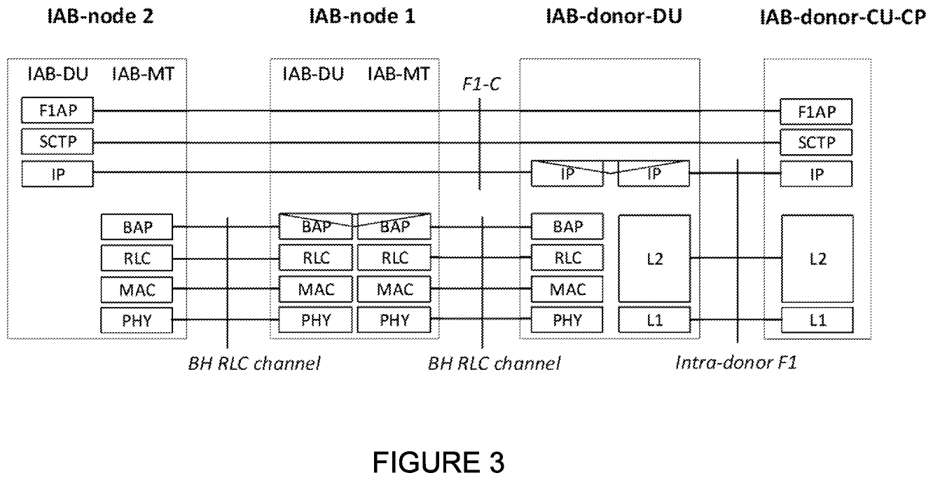

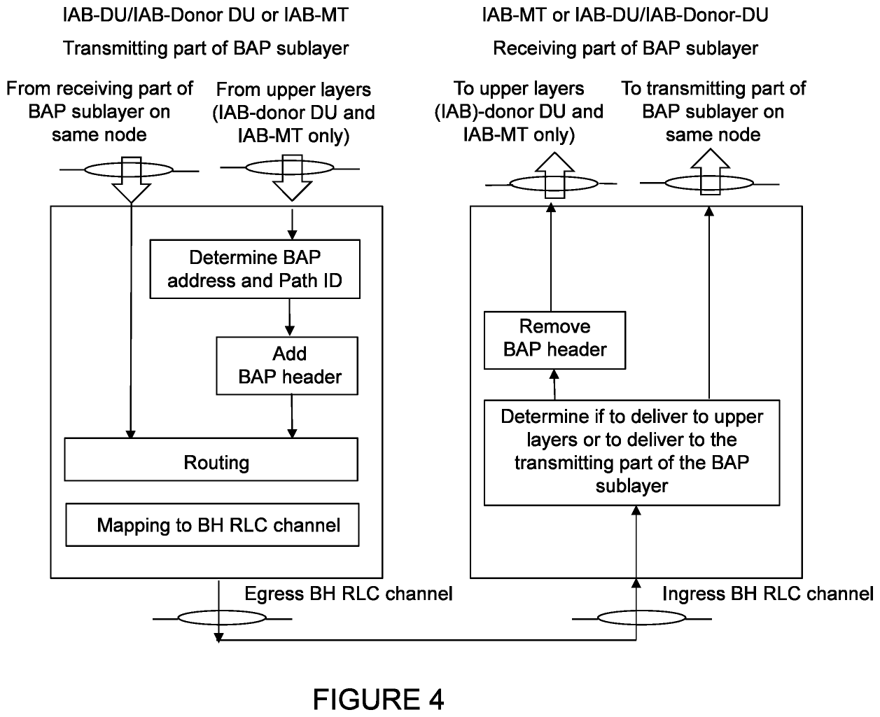

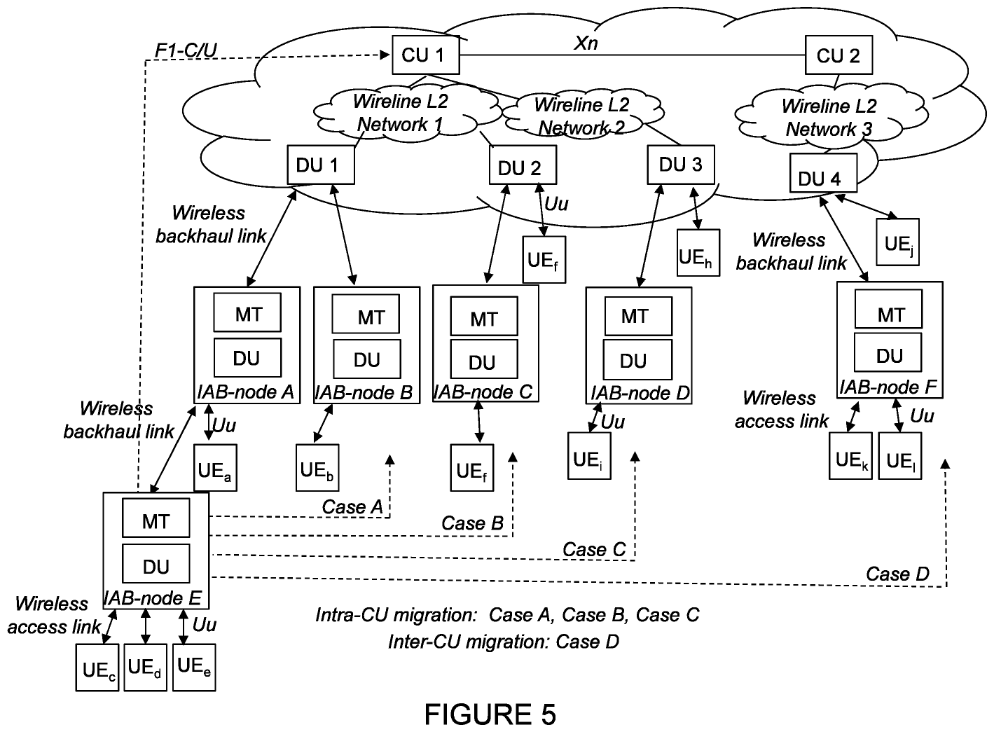

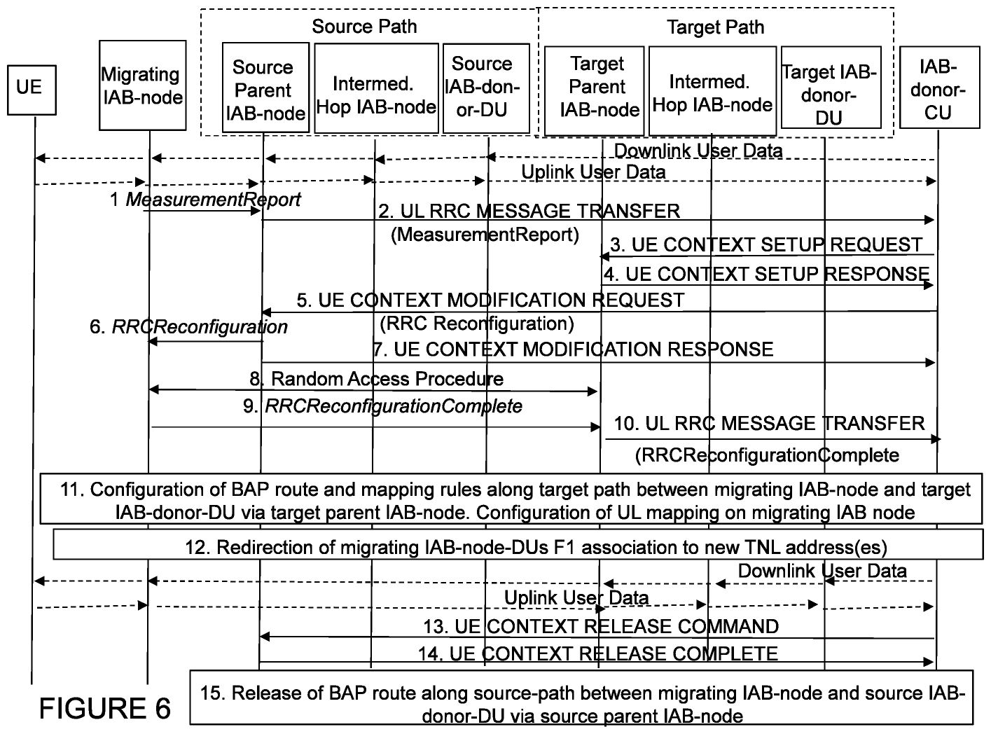

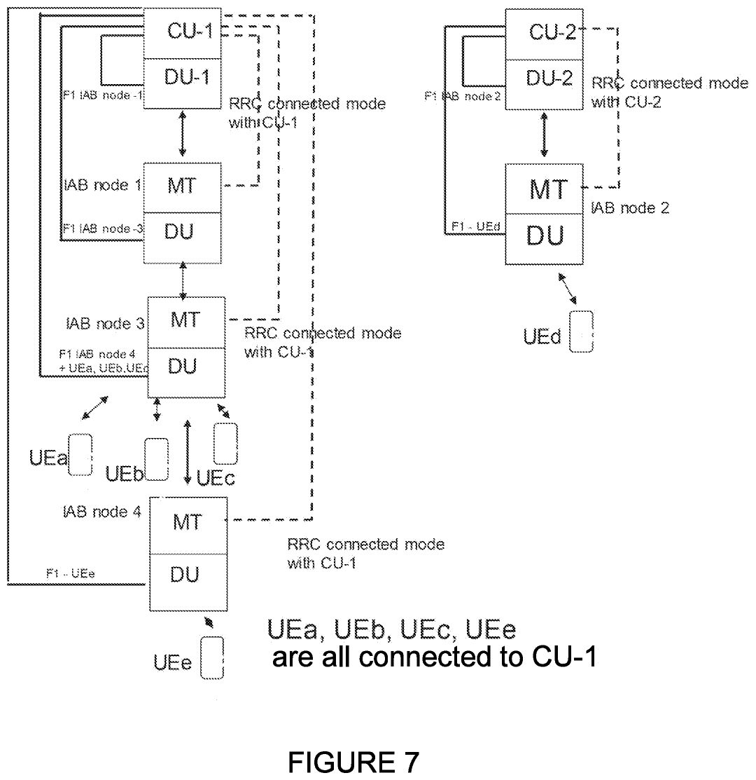

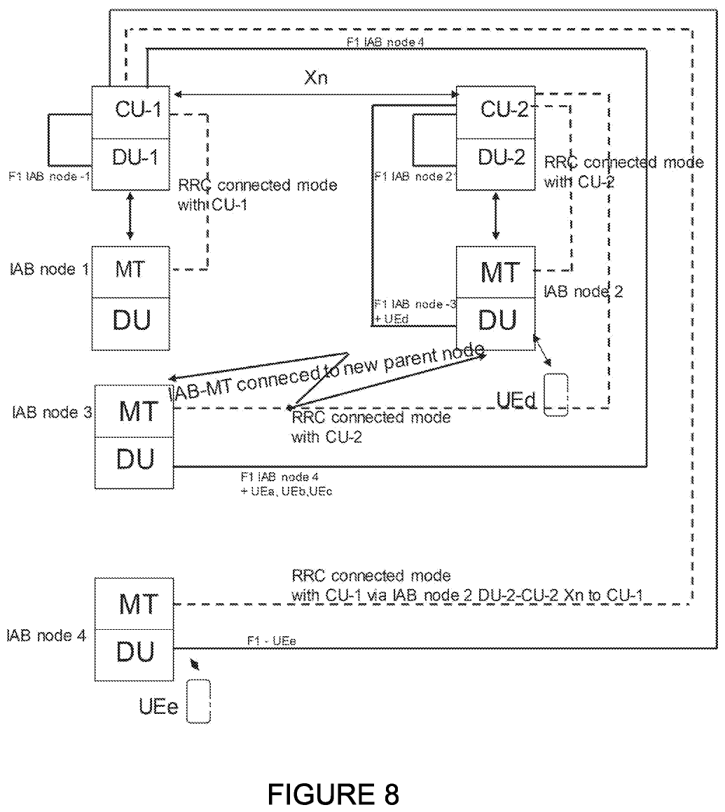

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

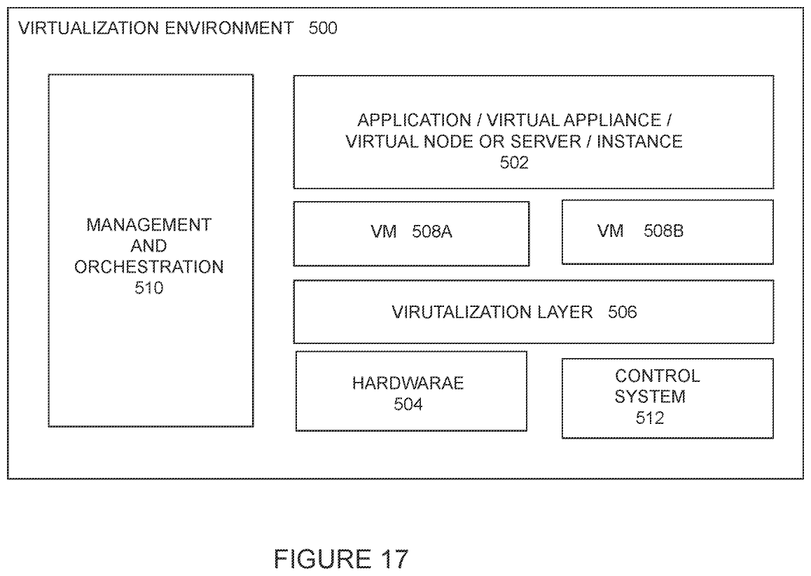

FIG. 17 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

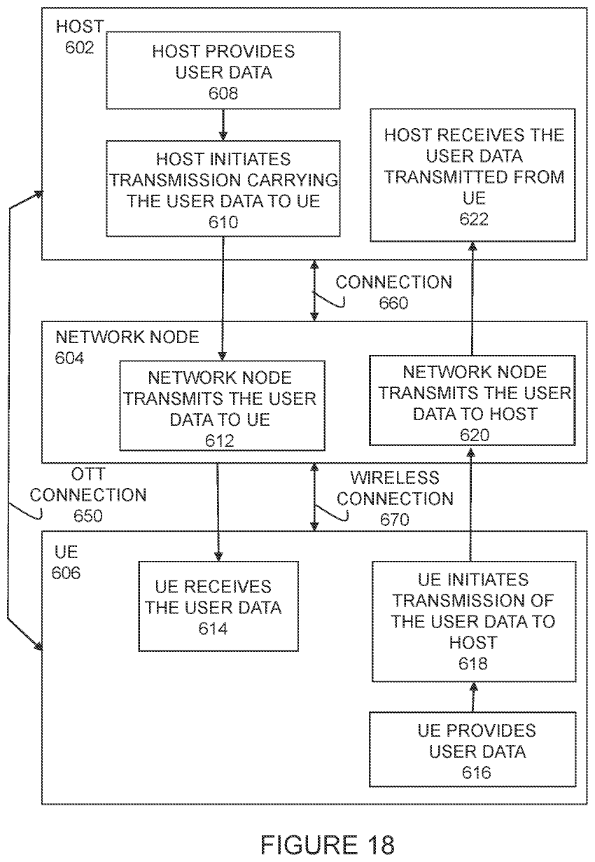

FIG. 18 shows a communication diagram of a host 602 communicating via a network node 604 with a UE 606 over a partially wireless connection in accordance with some embodiments.

Example implementations, in accordance with various embodiments, of the UE (such as a UE 112a of FIG. 13 and/or UE 200 of FIG. 14), network node (such as network node 110a of FIG. 13 and/or network node 300 of FIG. 15), and host (such as host 116 of FIG. 13 and/or host 400 of FIG. 16) discussed in the preceding paragraphs will now be described with reference to FIG. 18.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 13) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

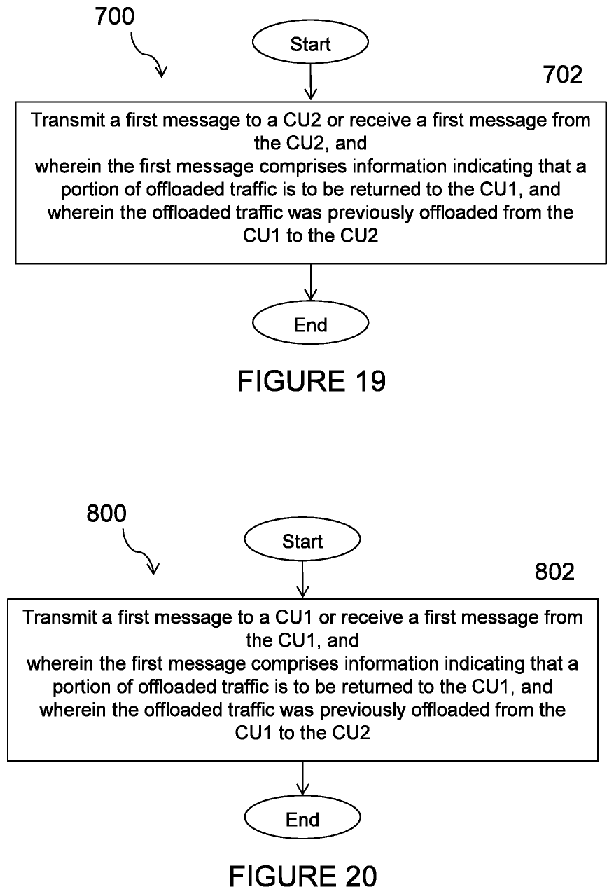

FIG. 19 illustrates a method 700 by a CU1 in an IAB network, according to certain embodiments. According to the method, at step 702, the CU1 transmits, at a first message to a CU2 or receives a first message from the CU2. The first message includes information indicating that a portion of offloaded traffic is to be returned to the CU1. The offloaded traffic was previously offloaded from the CU1 to the CU2.

In a particular embodiment, prior to transmitting the first message, the CU1 offloads the offloaded traffic from the first CU1 to the CU2.

In a particular embodiment, the offloaded traffic is terminated at a migrating IAB node.

In a particular embodiment, the CU1 receives the portion of the offloaded traffic that was previously offloaded from the CU1 to the CU2.

In a particular embodiment, the CU1 comprises a F1 termination node, and the CU2 comprises a F1 non-termination node.

In a particular embodiment, the first message indicates an amount traffic associated with the portion of the offloaded traffic to be returned to the CU1.

In a particular embodiment, the CU1 determines, prior to transmitting the first message, that the CU1 has a capacity to handle the portion of offloaded traffic to be returned to the CU1.

In a particular embodiment, the CU1 determines that a condition has been fulfilled, and the first message is transmitted to the CU2 in response to determining that the condition has been fulfilled, wherein the condition comprises at least one of: determining that a timer has expired; identifying a traffic load increase at the target donor node; identifying that traffic at the target donor node has increased more than a threshold amount; identifying a traffic load decrease at the source donor node; and identifying that traffic at the source donor node has decreased more than a threshold amount.

In a particular embodiment, the CU1 receives, from the CU2, a second message indicating at least one resource to be released by the CU2.

In a particular embodiment, the first message from the CU2 initiates the portion of offloaded traffic being returned to the CU1, and the method includes transmitting, to the CU2, a second message acknowledging the portion of the offloaded traffic being returned to the CU1.

In a particular embodiment, the first message indicates at least one granted resource associated with the portion of the offloaded traffic to be returned to the CU1.

In a particular embodiment, the at least one granted resource comprises at least one of: a downlink resource, and/or an uplink resource.

In a particular embodiment, the CU1 transmits, to at least one IAB node, information associated with the portion of the offloaded traffic to be returned to the CU1.

In a further particular embodiment, the information transmitted to the at least one IAB node comprises a routing table.

FIG. 20 illustrates a method 800 by a CU2 in an IAB network, according to certain embodiments. According to the method, at 802, the CU2 transmits a first message to a CU1 or receiving a first message from the CU1. The first message comprises information indicating that a portion of offloaded traffic is to be returned to the CU1, and the offloaded traffic was previously offloaded from the CU1 to the CU2.

In a particular embodiment, prior to transmitting the first message or receiving the first message, the CU2 receives the offloaded traffic.

In a further particular embodiment, the offloaded traffic is terminated at a migrating IAB node.

In a particular embodiment, the CU1 comprises a F1 termination node, and the CU2 comprises a F1 non-termination node.

In a particular embodiment, the first message indicates an amount traffic associated with the portion of the offloaded traffic to be returned to the CU1.

In a particular embodiment, the CU2 determines that the CU2 does not have a capacity to handle the portion of offloaded traffic to be returned to the CU1.

In a particular embodiment, the CU2 determines that a condition has been fulfilled, and the first message is transmitted to the CU1 in response to determining that the condition has been fulfilled. The condition comprises at least one of: determining that a timer has expired; identifying a traffic load increase at the target donor node; identifying that traffic at the target donor node has increased more than a threshold amount; identifying a traffic load decrease at the source donor node; and identifying that traffic at the source donor node has decreased more than a threshold amount.

In a particular embodiment, the CU2 receives, from the CU1, a second message indicating at least one resource to be released by the CU2.

In a particular embodiment, receiving the first message from the CU1 initiates the portion of offloaded traffic being returned to the CU1, and the CU2 transmits, to the CU1, a second message acknowledging the portion of the offloaded traffic being returned to the CU1.

In a particular embodiment, the first message indicates at least one granted resource associated with the portion of the offloaded traffic to be returned to the CU1.

In a particular embodiment, the at least one granted resource comprises at least one of: a downlink resource, and/or an uplink resource.

In a particular embodiment, the CU2 transmits, to at least one IAB node, information associated with the portion of the offloaded traffic to be returned to the CU1.

In a further particular embodiment, the information transmitted to the at least one IAB node comprises a routing table.

### EXAMPLE EMBODIMENTS

### Group A Example Embodiments

Example Embodiment A1. A method by a user equipment for temporary and/or adaptive load balancing in an Integrated Access and Backhaul, IAB, network, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for temporary and/or adaptive load balancing in an Integrated Access and Backhaul, IAB, network, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a source donor node for temporary and/or adaptive load balancing in an Integrated Access and Backhaul, IAB, network, the method comprising: determining traffic to be offloaded from the source donor node and/or traffic to be offloaded from a target donor node; and transmitting, to the target donor node, information associated with the traffic to be offloaded from the source donor node and/or the traffic to be offloaded from the target donor node.

Example Embodiment C2. The method of Example Emboidment C1, wherein the traffic is associated with a migrating IAB node.

Example Embodiment C3. The method of any one of Example Embodiments C1 to C2, wherein the traffic is determined for offloading from the source donor node to the target donor node.

Example Embodiment C4. The method of Example Emboidment C3, further comprising determining that the source donor node cannot handle the traffic to be offloaded from the source donor node to the target donor node.

Example Emboidment C5. The method of any one of Example Embodiments C3 to C4, further comprising determining an amount of traffic that the source donor cannot handle for offloading from the source donor node to the target node, and wherein the information indicates the amount of traffic for offloading from the source donor node to the target donor node.

Example Embodiment C6. The method of Example Embodiment C3 to C5, wherein the information comprises at least one requested resource for the traffic to be offloaded from the source node to the target node.

Example Embodiment C7. The method of Example Embodiment C6, wherein the at least one requested resource comprising at least one of: a downlink resource, and/or an uplink resource.

Example Embodiment C8. The method of any one of Example Embodiments C5 to C7, further comprising receiving, from the target donor node, a response message indicating at least one granted resource.

Example Embodiment C9. The method of Example Embodiment C8, wherein the at least one granted resource includes at least one requested resource indicated in the information transmitted to the target donor node.

Example Embodiment C10. The method of Example Embodiment C8, wherein the at least one granted resource does not include any resources requested in the information transmitted to the target donor node.

Example Embodiment C11. The method of any one of Example Embodiments C5 to C7, further comprising receiving, from the target donor node, a response message indicating that no resources are available from the target donor node.

Example Embodiment C12. The method of any one of Example Embodiments C3 to C11, further comprising offloading the traffic to the target donor node.

Example Embodiment C13. The method of any one of Example Embodiments C3 to C12, further comprising transmitting, to at least one IAB node, information associated with the traffic to be offloaded to the target donor node.

Example Embodiment C14. The method of Example Embodiment C13, wherein the information transmitted to the at least one IAB node comprises a routing table.

Example Embodiment C15. The method of any one of Example Embodiments C1 to C2, wherein the traffic is determined for offloading from the target donor node to the source donor node.

Example Embodiment C16. The method of Example Embodiment C15, wherein the traffic to be offloaded from the target donor node to the source donor node comprises traffic that was previously offloaded from the source donor node to the target donor node.

Example Embodiment C17.The method of any one of Example Embodiments C15 to C16, further comprising determining that the source donor node can handle the traffic to be offloaded from the target donor node to the source donor node.

Example Emboidment C18. The method of any one of Example Embodiments C15 to C17, further comprising receiving a message from the target donor node indicating an amount of traffic for offloading from the target donor node to the source donor node.

Example Embodiment C19. The method of any one of Example Embodiments C15 to C18, wherein the information transmitted to the target donor node indicates at least one granted resource associated with the traffic to be offloaded from the target donor node to the source donor node.

Example Embodiment C20.The method of Example Embodiment C119 wherein the at least one granted resource comprising at least one of: a downlink resource, and/or an uplink resource.

Example Embodiment C21. The method of any one of Example Embodiments C15 to C20, further comprising receiving, from the target donor node, a response message indicating at least one released resource to be released by the target donor node.

Example Embodiment C22. The method of Example Embodiment C21, wherein the at least one released resource includes the at least one granted resource identified in the information transmitted to the target donor node.

Example Embodiment C23. The method of Example Embodiment C21, wherein the at least one released resource does not include any granted resource identified in the information transmitted to the target donor node.

Example Embodiment C24. The method of any one of Example Embodiments C15 to C20, further comprising receiving, from the target donor node, a response message indicating that no resources are to be released by the target donor node.

Example Embodiment C25. The method of any one of Example Embodiments C15 to C23, further comprising receiving at least a portion of the traffic offloaded from the target donor node to the source donor node.

Example Embodiment C26. The method of any one of Example Embodiments C15 to C25, further comprising transmitting, to at least one IAB node, information associated with the traffic to be offloaded from the target donor node to the source donor node.

Example Embodiment C27.The method of Example Embodiment C26, wherein the information transmitted to the at least one IAB node comprises a routing table.

Example Embodiment C28. The method of any one of Example Embodiments C1 to C27, further maintaining a timer by the source donor node, and wherein the step of determining is performed upon expiration of the timer.

Example Embodiment C29. The method of any one of Example Embodiments C1 to C28, further comprising maintaining a timer by the source donor node, and wherein the information is transmitted to the target donor node upon expiration of the timer.

Example Embodiment C30 The method of any one of Example Embodiments C1 to C29, wherein the information transmitted to the target donor node comprises a traffic congestion status indicating whether the source donor node has capacity to handle the traffic to be offloaded from the target donor node and/or the traffic to be offloaded from the source donor node to the target donor node.

Example Emboidment C31. The method of Example Emboidment C30, further comprising maintaining a timer by the source donor node, and wherein the traffic congestion status is transmitted to the target donor node upon expiration of the timer.

Example Embodiment C32. The method of Example Embodiment C30, further comprising determining that a condition has been fulfilled, and wherein the traffic congestion status is transmitted to the target donor node in response to determining that the condition has been fulfilled.

Example Embodiment C33. The method of Example Embodiment C32, wherein the condition comprises at least one of: identifying a traffic load increase; identifying that traffic has increased more than a threshold amount; identifying a traffic load decrease; and identifying that traffic has decreased more than a threshold amount.

Example Emboidment C34. The method of any one of Example Embodiments C1 to C33, further comprising receiving a traffic congestion status from the target donor node, the traffic congestion status indicating whether the target donor node has capacity to handle traffic to be offloaded to from the source donor node and/or the traffic to be offloaded from the target donor node to the source donor node.

Example Embodiment C35. The method of Example Embodiment C34, further comprising transmitting, to the target donor node, a request for the traffic congestion status of the target donor node.

Example Embodiment C36. The method of Example Embodiment C35, further comprising maintaining a timer, and wherein the request for the traffic congestion status is transmitted to the target donor node upon expiration of the timer.

Example Emboidment C37. The method of any one of Example Embodiments C30 to C36, wherein the traffic congestion status indicates an amount of traffic that the source donor node and/or target donor node has capacity to handle.

Example Embodiment C38. The method of Example Embodiments C1 to C37, further comprising: providing user data; and forwarding the user data to a host via the transmission to the network node.

Example Embodiment C39. A source donor node comprising processing circuitry configured to perform any of the methods of Example Embodiments C1 to C38.

Example Embodiment C40. A source donor node adapted to perform any of the methods of Example Embodiments C1 to C38.

Example Embodiment C41. A computer program comprising instructions which when executed on a computer perform any of the methods of Example Embodiments C1 to C38.

Example Embodiment C42. A computer program product comprising computer program, the computer program comprising instructions which when executed on a computer perform any of the methods of Example Embodiments C1 to C38.

Example Embodiment C43. A non-transitory computer readable medium storing instructions which when executed by a computer perform any of the methods of Example Embodiments C1 to C38.

### Group D Example Embodiments

Example Embodiment D1. A method by a target donor node for temporary and/or adaptive load balancing in an Integrated Access and Backhaul, IAB, network, the method comprising: determining traffic to be offloaded from the target donor node and/or traffic to be offloaded from a source donor node; and transmitting, to the source donor node, information associated with the traffic to be offloaded from the target donor node and/or the traffic to be offloaded from the source donor node.

Example Embodiment D2. The method of Example Emboidment D1, wherein the traffic is associated with a migrating IAB node.

Example Embodiment D3. The method of any one of Example Embodiments D1 to D2, wherein the traffic is determined for offloading from the source donor node to the target donor node.

Example Embodiment D4. The method of Example Embodiment D3, wherein determining the traffic to be offloaded from the source donor node comprises receiving a request from the source donor node, the request identifying an amount of the traffic to be offloaded from the source donor node.

Example Embodiment D5. The method of Example Emboidment D3 to D4, further comprising determining that the target donor node can handle the traffic to be offloaded from the source donor node.

Example Emboidment D6. The method of any one of Example Embodiments D3 to D5, further comprising determining an amount of traffic that the target donor can handle for offloading from the source donor node to the target node, and wherein the information indicates the amount of traffic that the target donor can handle for offloading from the source donor node to the target donor node.

Example Embodiment D7. The method of any one of Example Embodiments D3 to D6, wherein the information comprises at least one granted resource for the traffic to be offloaded from the source donor node to the target donor node.

Example Embodiment D8. The method of Example Embodiment D7, wherein the at least one granted resource comprising at least one of: a downlink resource, and/or an uplink resource.

Example Embodiment D9. The method of any one of Example Embodiments D7 to D8, further comprising receiving, from the source donor node, a response message accepting the at least one granted resource.

Example Embodiment D10. The method of any one of Example Embodiments D7 to D8, further comprising receiving, from the source donor node, a response message indicating that the source donor node does not need to offload the traffic to the target donor node.

Example Embodiment D11. The method of any one of Example Embodiments D3 to D10, further comprising receiving at least a portion of the traffic offloaded to the target donor node.

Example Embodiment D12. The method of any one of Example Embodiments D3 to D11, further comprising transmitting, to at least one IAB node, information associated with the traffic to be offloaded to the target donor node.

Example Embodiment D13. The method of Example Embodiment D12, wherein the information transmitted to the at least one IAB node comprises a routing table.

Example Embodiment D14. The method of any one of Example Embodiments D1 to D2, wherein the traffic is determined for offloading from the target donor node to the source donor node.

Example Embodiment D15. The method of Example Embodiment D14, wherein determining the traffic to be offloaded from the target donor node comprises receiving a message from the source donor node indicating that the source donor node can handle the traffic to be offloaded from the target donor node.

Example Embodiment D16. The method of Example Embodiment D15, wherein the message from the source donor node indicates an amount of the traffic that the source donor node can handle.

Example Embodiment D17. The method of Example Emboidment D14 to D16, further comprising determining that the target donor node cannot handle the traffic to be offloaded from the target donor node.

Example Emboidment D18. The method of any one of Example Embodiments D14 to D17, further comprising determining an amount of traffic for offloading from the target donor node to the source node, and wherein the information indicates the amount of traffic for offloading from the target donor node to the source donor node.

Example Embodiment D19. The method of any one of Example Embodiments D14 to D18, wherein the traffic to be offloaded from the target donor node to the source donor node comprises traffic that was previously offloaded from the source donor node to the target donor node.

Example Embodiment D20. The method of any one of Example Embodiments D14 to D19, wherein the information indicates at least one released resource associated with the traffic to be offloaded from the target donor node to the source donor node.

Example Embodiment D21. The method of Example Embodiment D20, wherein the at least one released resource comprising at least one of: a downlink resource, and/or an uplink resource.

Example Embodiment D22. The method of any one of Example Embodiments D20 to D22, further comprising receiving, from the source donor node, a response message indicating at least one granted resource associated with the traffic to be offloaded from the target donor node to the source target node.

Example Embodiment D23. The method of Example Embodiment D22, wherein the at least one granted resource in the response message includes the at least one released resource identified in the information transmitted to the source donor node.

Example Embodiment D24. The method of Example Embodiment D22, wherein the at least one granted resource in the response message does not include any of the released resources identified in the information transmitted by the target donor node to the source network node.

Example Embodiment D25. The method of any one of Example Embodiments D20 to D21, further comprising receiving, from the source donor node, a response message indicating that no resources are to be accepted by the source donor node.

Example Embodiment D26. The method of any one of Example Embodiments D14 to D25, further comprising offloading at least a portion of the traffic to the source donor node.

Example Embodiment D27. The method of any one of Example Embodiments D14 to D26, further comprising transmitting, to at least one IAB node, information associated with the traffic to be offloaded from the target donor node to the source donor node.

Example Embodiment D28. The method of Example Embodiment D27, wherein the information transmitted to the at least one IAB node comprises a routing table.

Example Embodiment D29. The method of any one of Example Embodiments D1 to D28, further maintaining a timer by the target donor node, and wherein the step of determining is performed upon expiration of the timer.

Example Embodiment D30. The method of any one of Example Embodiments D1 to D29, further comprising maintaining a timer by the target donor node, and wherein the information is transmitted to the source donor node upon expiration of the timer.

Example Embodiment D31. The method of any one of Example Embodiments D1 to D30, wherein the information transmitted to the source donor node comprises a traffic congestion status indicating whether the target donor node has capacity to handle the traffic to be offloaded from the source donor node and/or the traffic to be offloaded from the target donor node to the source donor node.

Example Emboidment D32. The method of Example Emboidment D31, further comprising maintaining a timer by the target donor node, and wherein the traffic congestion status is transmitted to the source donor node upon expiration of the timer.

Example Embodiment D33. The method of Example Embodiment D31, further comprising determining that a condition has been fulfilled, and wherein the traffic congestion status is transmitted to the source donor node in response to determining that the condition has been fulfilled.

Example Embodiment D34. The method of Example Embodiment D33, wherein the condition comprises at least one of: identifying a traffic load increase; identifying that traffic has increased more than a threshold amount; identifying a traffic load decrease; and identifying that traffic has decreased more than a threshold amount.

Example Emboidment D35. The method of any one of Example Embodiments D1 to D34, further comprising receiving a traffic congestion status from the source donor node, the traffic congestion status indicating whether the source donor node has capacity to handle traffic to be offloaded from the source donor node to the target donor node and/or the traffic to be offloaded from the target donor node to the source donor node.

Example Embodiment D36. The method of Example Embodiment D35, further comprising transmitting, to the source donor node, a request for the traffic congestion status of the source donor node.

Example Embodiment D37. The method of Example Embodiment D36, further comprising maintaining a timer, and wherein the request for the traffic congestion status is transmitted to the source donor node upon expiration of the timer.

Example Emboidment D38. The method of any one of Example Embodiments D31 to D37, wherein the traffic congestion status indicates an amount of traffic that the source donor node and/or target donor node has capacity to handle.

Example Embodiment D39. The method of Example Embodiments D1 to D38, further comprising: providing user data; and forwarding the user data to a host via the transmission to the network node.

Example Embodiment D40. A target donor node comprising processing circuitry configured to perform any of the methods of Example Embodiments D1 to D39.

Example Embodiment D41. A target donor node adapted to perform any of the methods of Example Embodiments D1 to D39.

Example Embodiment D42. A computer program comprising instructions which when executed on a computer perform any of the methods of Example Embodiments D1 to D39.

Example Embodiment D43. A computer program product comprising computer program, the computer program comprising instructions which when executed on a computer perform any of the methods of Example Embodiments D1 to D39.

Example Embodiment D44. A non-transitory computer readable medium storing instructions which when executed by a computer perform any of the methods of Example Embodiments D1 to D39.

### Group E Example Embodiments

Example Embodiment E1. A network node for temporary and/or adaptive load balancing in an Integrated Access and Backhaul, IAB, network, the network node comprising: processing circuitry configured to perform any of the steps of any of the Group A and B Example Embodiments; power supply circuitry configured to supply power to the processing circuitry.

Example Embodiment E2. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group A and B Example Embodiments to transmit the user data from the host to the UE.

Example Embodiment E3. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E4. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group A and B Example Embodiments to transmit the user data from the host to the UE.

Example Embodiment E5. The method of the previous Example Embodiment, further comprising, at the network node, transmitting the user data provided by the host for the UE.

Example Emboidment E6. The method of any of the previous 2 Example Embodiments, wherein the user data is provided at the host by executing a host application that interacts with a client application executing on the UE, the client application being associated with the host application.

Example Embodiment E7. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group A and B Example Embodiments to transmit the user data from the host to the UE.

Example Embodiment E8. The communication system of the previous Example Embodiment, further comprising: the network node; and/or the user equipment.

Example Embodiment E9. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group A and B Example Embodiments to receive the user data from a user equipment (UE) for the host.

Example Embodiment E10. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E11. The host of the any of the previous 2 Example Embodiments, wherein the initiating receipt of the user data comprises requesting the user data.

Example Embodiment E12. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group A and B Example Embodiments to receive the user data from the UE for the host.

Example Embodiment E13. The method of the previous Example Embodiment, further comprising at the network node, transmitting the received user data to the host.

1. A method by a first Centralized Unit, CU1, in an Integrated Access and Backhaul, IAB, network, the method comprising:
transmitting a first message to a second CU, CU2, or receiving a first message from the CU2, and
wherein the first message comprises information indicating that a portion of offloaded traffic is to be returned to the CU1, and
wherein the offloaded traffic was previously offloaded from the CU1 to the CU2.

2. The method of claim 1, comprising:
prior to transmitting the first message, offloading the offloaded traffic from the first CU1 to the CU2.

3. The method of claim 2, wherein the offloaded traffic is terminated at a migrating IAB node.

4. The method of claim 1, further comprising receiving the portion of the offloaded traffic that was previously offloaded from the CU1 to the CU2.

5. The method of claim 1, wherein:
the CU1 comprises a F1 termination node, and
the CU2 comprises a F1 non-termination node.

6. The method of claim 1, wherein the first message indicates an amount traffic associated with the portion of the offloaded traffic to be returned to the CU1.

7. The method of claim 1, further comprising determining that the CU1 has a capacity to handle the portion of offloaded traffic to be returned to the CU1.

8. The method of claim 1, further comprising determining that a condition has been fulfilled, and wherein the first message is transmitted to the CU2 in response to determining that the condition has been fulfilled, wherein the condition comprises at least one of:
determining that a timer has expired;
identifying a traffic load increase at the target donor node;
identifying that traffic at the target donor node has increased more than a threshold amount;
identifying a traffic load decrease at the source donor node; and
identifying that traffic at the source donor node has decreased more than a threshold amount.

9. The method of claim 7, further comprising receiving, from the CU2, a second message indicating at least one resource to be released by the CU2.

10. (canceled)

11. The method of claim 1, wherein the first message indicates at least one granted resource associated with the portion of the offloaded traffic to be returned to the CU1.

12. (canceled)

13. The method of claim 1, further comprising transmitting, to at least one IAB node, information associated with the portion of the offloaded traffic to be returned to the CU1.

14. The method of claim 13, wherein the information transmitted to the at least one IAB node comprises a routing table.

15. A method by a second Centralized Unit, CU2, in an Integrated Access and Backhaul, IAB, network, the method comprising:
transmitting a first message to a CU1 or receiving a first message from the CU1, and wherein the first message comprises information indicating that a portion of offloaded traffic is to be returned to the CU1, and
wherein the offloaded traffic was previously offloaded from the CU1 to the CU2.

16.-17. (canceled)

18. The method of claim 15, wherein:
the CU1 comprises a F1 termination node, and
the CU2 comprises a F1 non-termination node.

19. The method of claim 15, wherein the first message indicates an amount traffic associated with the portion of the offloaded traffic to be returned to the CU1.

20. (canceled)

21. The method of claim 1, further comprising determining that a condition has been fulfilled, and wherein the first message is transmitted to the CU1 in response to determining that the condition has been fulfilled, wherein the condition comprises at least one of:
determining that a timer has expired;
identifying a traffic load increase at the target donor node;
identifying that traffic at the target donor node has increased more than a threshold amount;
identifying a traffic load decrease at the source donor node; and
identifying that traffic at the source donor node has decreased more than a threshold amount.

22. The method of claim 21, further comprising receiving, from the CU1, a second message indicating at least one resource to be released by the CU2.

23. (canceled)

24. The method of claim 15, wherein the first message indicates at least one granted resource associated with the portion of the offloaded traffic to be returned to the CU1.

25. The method of claim 24, wherein the at least one granted resource comprises at least one of:
a downlink resource, and/or
an uplink resource.

26. The method of claim 15, further comprising transmitting, to at least one IAB node, information associated with the portion of the offloaded traffic to be returned to the CU1.

27. (canceled)

28. A first Centralized Unit, CU1, in an Integrated Access and Backhaul, IAB, network, the CU1 adapted to:
transmit a first message to a second CU, CU2, or receiving a first message from the CU2, and
wherein the first message comprises information indicating that a portion of offloaded traffic is to be returned to the CU1, and
wherein the offloaded traffic was previously offloaded from the CU1 to the CU2.

29. The source donor node of claim 28, further adapted to, prior to transmitting the first message, offload the offloaded traffic from the first CU1 to the CU2.

30. A second Centralized Unit, CU2, in an Integrated Access and Backhaul, IAB, network, the CU2 adapted to:
transmit a first message to a CU1 or receiving a first message from the CU1, and wherein the first message comprises information indicating that a portion of offloaded traffic is to be returned to the CU1, and
wherein the offloaded traffic was previously offloaded from the CU1 to the CU2.

31. The target donor node of claim 30, wherein:
the CU1 comprises a F1 termination node, and
the CU2 comprises a F1 non-termination node.
